(19) United States
(12) Patent Application Publication
(10) Pub. No.: US 2008/0147964 A1
(43) Pub. Date: Jun. 19, 2008

(54) USING VARIOUS FLASH MEMORY CELLS TO BUILD USB DATA FLASH CARDS WITH MULTIPLE PARTITIONS AND AUTORUN FUNCTION

(76) Inventors: David Q. Chow, San Jose, CA (US); Charles C. Lee, Cupertino, CA (US); Frank I-Kang Yu, Palo Alto, CA (US); Abraham C. Ma, Fremont, CA (US); Ming-Shiang Shen, Taipei City (TW)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/867,610

(22) Filed: Oct. 4, 2007

Related U.S. Application Data
(63) Continuation-in-part of application No. 11/671,431, filed on Feb. 5, 2007.
Application No. 11/671,431 is a continuation-in-part of application No. 11/466,759, filed on Aug. 23, 2006.
Application No. 11/466,759 is a continuation-in-part of application No. 10/789,333, filed on Feb. 26, 2004, now Pat. No. 7,318,117.

(51) Int. Cl. G06F 12/00

(52) U.S. Cl. 711/103; 711/E12.001

(57) ABSTRACT

An electronic data flash card includes a processor and at least one flash memory device. The flash memory is partitioned such that it includes a first partition that is formatted using a file system that supports an Autorun function (e.g., CD-ROM file system (CDFS) format, fixed-disk format or Universal Disk Format (UDF)), and a disk partition that is formatted using a typical controller-based flash device file system (e.g., 16-bit File Allocation Table (FAT16) file system, 32-bit FAT (FAT32) file system, or New Technology File System (NTFS)). The electronic data flash card is produced such that Autorun-enabled application automatically executes a predetermined application or action when the electronic data flash card is installed in a host system. In one embodiment, the Autorun application includes an advertisement displayed on the host system prior to allowing access to data stored in the disk partition.

### RELATED APPLICATIONS

This application is a continuation-in-part (CIP) of co-pending U.S. patent application for “USB Electronic Data Flash Card with Multiple Partitions and Autorun Function”, U.S. application Ser. No. 11/671,431, filed Feb. 5, 2007, which is a CIP of U.S. patent application for “Flash Memory Controller For Electronic Data Flash Card”, U.S. application Ser. No. 11/466,759, filed on Aug. 23, 2006, which is a CIP of “System and Method for Controlling Flash Memory”, U.S. application Ser. No. 10/789,333, filed on Feb. 26, 2004, now abandoned. This application is also related to “Integrated circuit card with fingerprint verification capability” application Ser. No. 09/366,976, filed on Aug. 4, 1999, now U.S. Pat. No. 6,547,130 and “Electronic Data Storage Medium With Fingerprint Verification Capability”, U.S. application Ser. No. 09/478,720, filed Jan. 6, 2000, now U.S. Pat. No. 7,257,714, all of which are incorporated herein as though set forth in full.

### FIELD OF THE INVENTION

The present invention relates to an electronic data flash card, and more particularly to multiple function flash memory systems for electronic data flash cards.

### BACKGROUND OF THE INVENTION

Confidential data files are often stored in floppy disks or are delivered via networks that require passwords or that use encryption coding for security. Confidential documents are sent by adding safety seals and impressions during delivery. However, confidential data files and documents are exposed to the danger that the passwords, encryption codes, safety seals and impressions may be broken (deciphered), thereby resulting in unauthorized access to the confidential information.

As flash memory technology becomes more advanced, flash memory is replacing traditional magnetic disks as storage media for mobile systems. Flash memory has significant advantages over floppy disks or magnetic hard disks such as having a high-G resistance and a low power dissipation. Because of the smaller physical size of a flash memory, they are also more conducive to mobile systems. Accordingly, the flash memory trend has been growing because of its compatibility with portable (mobile) systems and a low-power feature.

USB electronic data flash cards are portable, low power devices that utilize Universal Serial Bus (USB) technology to interface between a host computer and a flash memory device of the flash card. USB electronic data flash cards take many forms, such as pen drive storage devices, MP3 players, and digital cameras. In each instance, the USB electronic data flash card typically includes a flash memory device, a processor, and USB interface circuitry.

USB flash memory devices are popular devices used for data storage. While conventional USB flash memory devices are limited to data storage, they are popular because they are portable, easily erasable, and easily formatted. A potential problem with conventional USB flash memory devices is that because they are easily erasable and easily formatted, they can be accidentally erased or reformatted. Accordingly, USB flash memory devices are typically used for transporting data, and not as permanent storage. Data stored on USB flash memory devices is typically backed up elsewhere, such as on a hard drive.

Accordingly, what is needed is an improved flash memory system. The system should be flexible, secure, simple, cost effective, and capable of being easily adapted to existing technology. The present invention addresses such a need.

### SUMMARY OF THE INVENTION

Embodiments of the present invention are generally directed to an electronic data flash card including a flash memory device, an optional fingerprint sensor, an input-output interface circuit and a processing unit. The electronic data flash card is adapted to be accessed by a host (external) computer such as a personal computer, notebook computer or other electronic host device. As an electronic data flash card is easier to carry and durable for ruggedness, personal data can be stored inside the flash memory device in an encrypted form such that it can only be accessed, for example, by way of the optional fingerprint sensor associated with card body to make sure unauthorized person cannot misuse the card.

An embodiment of the present invention is particularly directed to an electronic data flash card in which the flash memory cells of the flash memory are partitioned using formatting techniques similar to those used to format “hard” disk drives to include at least one partition including an Autorun function (i.e., an Autorun.inf file and at least one application file containing a software application launched by the Autorun.inf file at start-up), and one or more disk partitions for storing user-accessible data. The “autorun” partition is formatted using a file system that supports/facilitates the Autorun function (e.g., CD-ROM file system (CDFS) or Universal File System (UFS)), and the disk partition is formatted using a typical data storage file system (e.g., 16-bit File Allocation Table (FAT16) file system, 32-bit File Allocation Table (FAT32) file system, or New Technology (NT) File System (NTFS)). In one embodiment, the autorun partition is not accessible to an end user, and is only accessible by way of a special utility and a manufacturer-defined password.

In accordance with another embodiment of the present invention, when a communication link between an electronic data flash card and a host computer is established, the electronic data flash card is initialized, and then automatically executes commands stored in Autorun.inf file (i.e., either executes the software application using the card's controller, or causes the host computer to execute the software application). After initiating (and in some cases entirely completing) the execution of the software application, the flash memory controller enters a “normal” operating mode including one of: a programming mode in which the flash memory controller activates the input/output interface circuit to receive a data file from the host computer, and stores the data file in the disk partition; a data retrieving mode in which the flash memory controller reads the data file from the disk partition, and activates the input/output interface circuit to transmit the data file to the host computer; and a data resetting mode in which the flash memory controller erases the data file from the disk partition). By partitioning a flash memory device into two or more partitions that include both an autorun partition and a disk partition, an embodiment of the present invention provides an enhanced electronic data flash card that facilitates operations that are not possible with a flash card having only a single partition.

### BRIEF DESCRIPTION OF THE DRAWINGS

These and other features, aspects and advantages of the present invention will become better understood with regard to the following description, appended claims, and accompanying drawings, where:

FIG. 1(A) is a block diagram showing an electronic data flash card and host system according to an embodiment of the present invention.

FIG. 1(B) is a block diagram showing an electronic data flash card and host system according to another embodiment of the present invention.

FIG. 1(C) is a block diagram showing the electronic data flash card of FIG. 1(B) in additional detail according to one embodiment of the invention.

FIG. 1(D) is a block diagram of a processing unit utilized in an electronic data flash card in accordance with another embodiment of the present invention.

FIG. 2 is a simplified flow chart showing a method for operating the flash memory system of FIG. 1(D) in accordance with an embodiment of the present invention.

FIG. 3 is a block diagram of a flash memory system in accordance with another embodiment of the present invention.

FIG. 4 is a detailed block diagram of a flash memory system, which can be used to implement the flash memory system of FIG. 3, in accordance with an embodiment of the present invention.

FIG. 5 is a translation table, which can be used to implement the index of FIG. 3 or the address translation table of FIG. 4, in accordance with an embodiment of the present invention.

FIGS. 6(A) and 6(B) are exemplary applications of the address translation table of FIG. 5 in accordance with an embodiment of the present invention.

FIGS. 7/1 and 7/2 are flow charts showing a method for providing the translation table of FIG. 5 in accordance with an embodiment of the present invention.

FIGS. 8/1 and 8/2 are translation tables in accordance with another embodiment of the present invention.

FIG. 9 is a flow chart showing a method for constructing the translation table of FIG. 8 in accordance with a specific embodiment of the present invention.

FIG. 10 is a flow chart showing a method for programming a flash memory system of FIG. 4 in accordance with one embodiment of the present invention.

FIG. 11 is a flow chart showing a method for setting-up an AutoRun function with a manufacturing host in accordance with one embodiment of the present invention.

FIG. 12 is a flow chart showing a method for running an AutoRun function user mode in accordance with one embodiment of the present invention.

FIG. 13 is a flow chart showing a method for booting up a read-only memory (ROM), in accordance with one embodiment of the present invention.

FIG. 14 is a flow chart showing a method for setting up a security partition of the manufacturing test in accordance with an embodiment of the present invention.

FIG. 14A is a block diagram illustrating a data block of a flash memory device according to one embodiment of the invention.

FIG. 15 is a flow chart showing a method for operating a security partition in user mode in accordance with an embodiment of the present invention.

FIG. 16 is a flow diagram illustrating a process for providing a protection of a flash memory device according to one embodiment of the invention.

### DETAILED DESCRIPTION

Embodiments of the present invention relate to an improvement in methods for producing electronic data flash cards. Although embodiments of the present invention are described below with specific reference to USB electronic data flash cards, the present novel aspects of the present invention can be used in manufacturing a wide range of flash card types, including but not limited to PCI Express, Secure Digital (SD), Memory Stick (MS), Compact Flash (CF), IDE and SATA flash memory cards, such applications can also be adopted in various Vertical-Helical-Scan (VHS) and Digital-Versatile-Disk (DVD) format to auto-play the media contents inside. Whenever Autorun device is plugged in the host machine, it can fulfill the same function as today's popular media carrier does.

In the following description, numerous details are set forth to provide a more thorough explanation of embodiments of the present invention. It will be apparent, however, to one skilled in the art, that embodiments of the present invention may be practiced without these specific details. In other instances, well-known structures and devices are shown in block diagram form, rather than in detail, in order to avoid obscuring embodiments of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification do not necessarily all refer to the same embodiment.

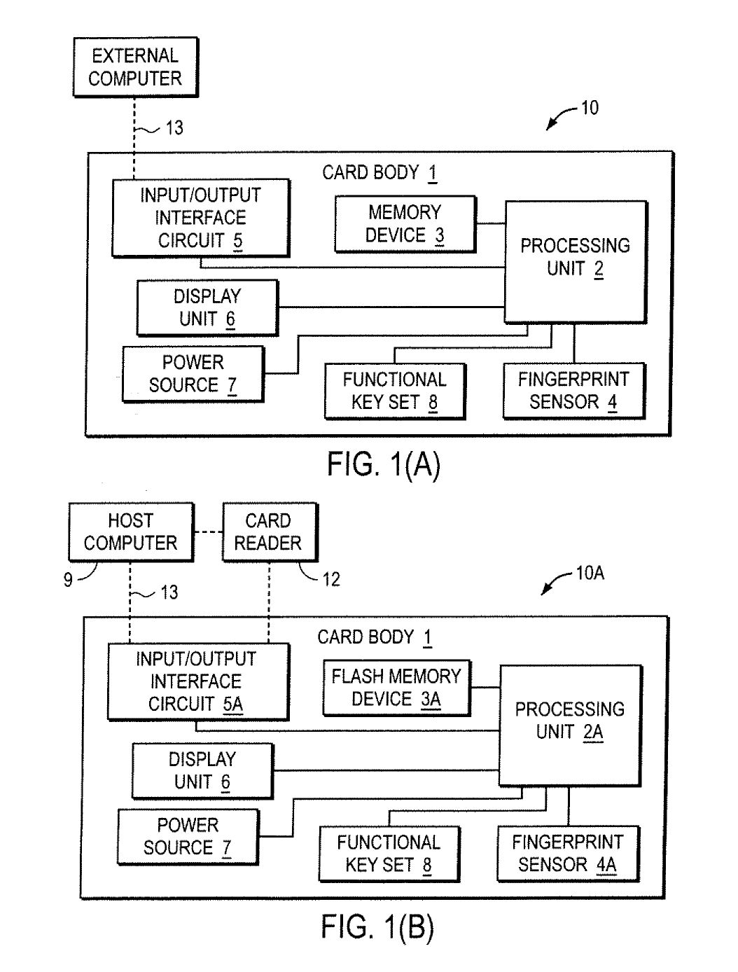

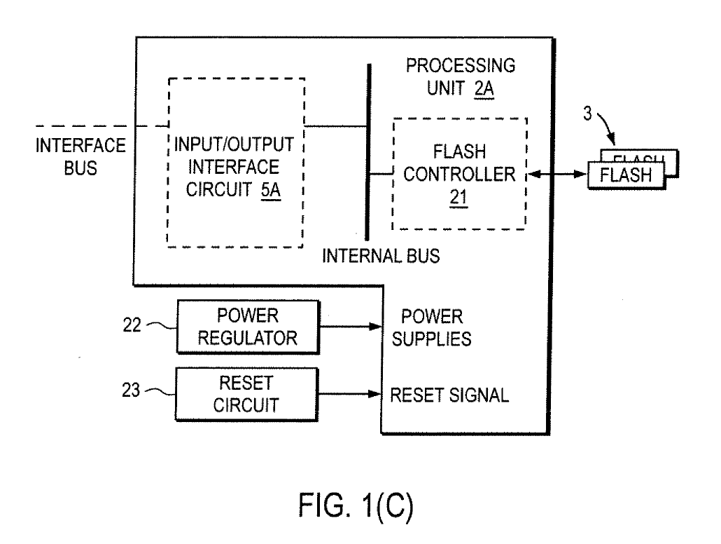

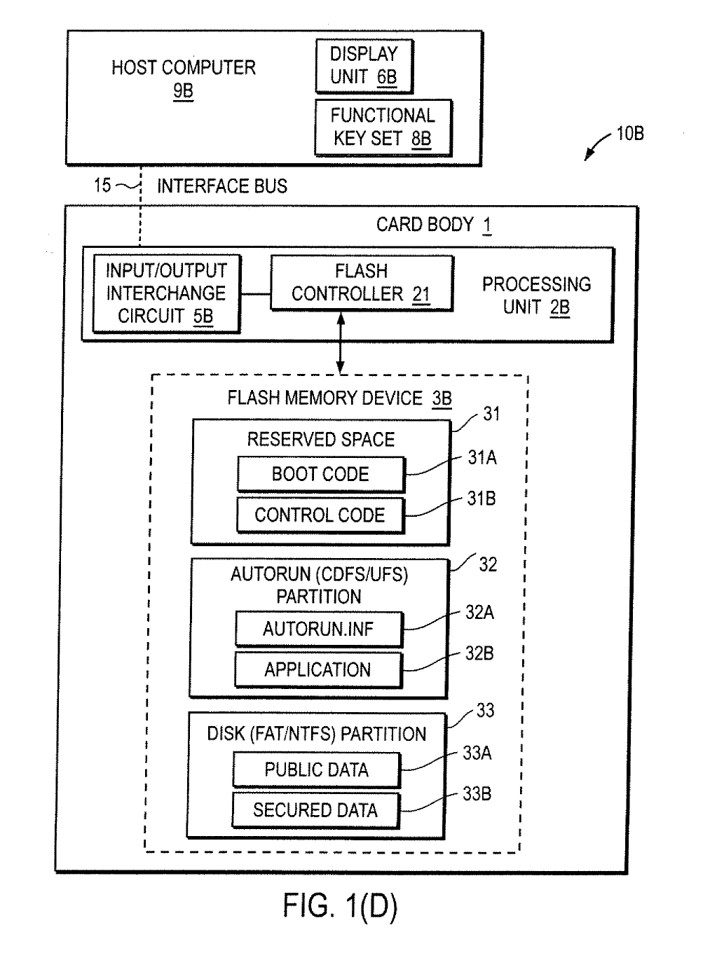

Referring to FIG. 1(A), according to an embodiment of the present invention, an electronic data flash card 10 is adapted to be accessed by an external (host) computer 9 either via an interface bus 13 or a card reader (not shown) or other interface mechanism (not shown), and includes a card body 1, a processing unit 2, one or more flash memory devices 3, an optional fingerprint sensor (security device) 4, an input/output interface circuit 5, an optional display unit 6, an optional power source (e.g., battery) 7, and an optional function key set 8.

Flash memory device 3 is mounted on the card body 1, and stores in a known manner therein a data file, a reference password, and fingerprint reference data obtained by scanning a fingerprint of a person authorized to access the data file. The data file can be, for example, a picture file or a text file. As set forth below, the flash memory device 3 also includes boot code data and control code data.

The fingerprint sensor 4 is mounted on the card body 1, and is adapted to scan a fingerprint of a user of electronic data flash card 10 to generate fingerprint scan data. One example of the fingerprint sensor 4 that can be used in the present invention is that disclosed in a co-owned U.S. Pat. No. 6,547,130, entitled “INTEGRATED CIRCUIT CARD WITH FINGERPRINT VERIFICATION CAPABILITY”, the entire disclosure of which is incorporated herein by reference. The fingerprint sensor described in the above patent includes an array of scan cells that defines a fingerprint scanning area. The fingerprint scan data includes a plurality of scan line data obtained by scanning corresponding lines of array of scan cells. The lines of array of scan cells are scanned in a row direction as well as a column direction of the array. Each of the scan cells generates a first logic signal upon detection of a ridge in the fingerprint of the holder of card body, and a second logic signal upon detection of a valley in the fingerprint of the holder of card body.

The input/output interface circuit 5 is mounted on the card body 1, and can be activated so as to establish communication with the host computer 9 by way of an appropriate socket via an interface bus 13 or a card reader. In one embodiment, input/output interface circuit 5 includes circuits and control logic associated with one of a Universal Serial Bus (USB), PCMCIA and RS232 interface structure that is connectable to an associated socket connected to or mounted on the host computer 9. In another embodiment, the input/output interface circuit 5 may include one of a Secure Digital (SD) interface circuit, a Multi-Media Card (MMC) interface circuit, a Compact Flash (CF) interface circuit, a Memory Stick (MS) interface circuit, a PCI-Express interface circuit, a Integrated Drive Electronics (IDE) interface circuit, and a Serial Advanced Technology Attachment (SATA) interface circuit, which interface with the host computer 9 via an interface bus 13 or a card reader.

The processing unit 2 is mounted on the card body 1, and is connected to the memory device 3, the fingerprint sensor 4 and the input/output interface circuit 5 by way of associated conductive traces or wires disposed on card body 1. In one embodiment, processing unit 2 is one of an 8051, 8052, and 80286 microprocessors available, for example, from Intel Corporation. In other embodiments, processing unit 2 includes a RISC, ARM, MIPS or other digital signal processors. In accordance with an aspect of the present invention, processing unit 2 is controlled by a program stored at least partially in flash memory device 3 such that processing unit 2 is operable selectively in: (1) a programming mode, where the processing unit 2 activates the input/output interface circuit 5 to receive the data file, the boot code data, the control code data, and optional fingerprint reference data from the host computer 9, and to store the data in the flash memory device 3 (as an option, in a compressed format to increase storage capacity of the memory device 3); (2) a reset mode in which the boot code data and the control code data are read from the flash memory device and utilized to configure and control the operation of the processing unit 2; (3) a data retrieving mode, where the processing unit 2 reads the fingerprint scan data from the fingerprint sensor 4, compares the fingerprint scan data with at least a segment of the fingerprint reference data in the flash memory device 3 to verify if the user of the electronic data flash card 10 is authorized to access the data file stored in the flash memory device 3, and activates the input/output interface circuit 5 to transmit the data file to the host computer 9 upon verifying that the user is authorized to access the data file stored in the flash memory device 3; (4) a code updating mode in which the boot code data and the control code data are updated in the memory device 3; and (5) a data resetting mode, where the data file and the fingerprint reference data are erased from the memory device 3. In operation, host computer 9 sends write and read requests to electronic data flash card 10 via a card reader or interface bus 13 and input/output interface circuit 5 to the processing unit 2, which in turn utilizes a flash memory controller (not shown) to read from and/or write to the associated one or more flash memory device 3. In one embodiment, the processing unit 2 automatically initiates the data resetting mode operation upon detecting that a preset time period has elapsed since storage of the data file and the fingerprint reference data in the memory device 3.

8051, 8052 and 80286 processors are microprocessors developed by Intel Corporation, using a complex instruction set. 8051 and 8052 microprocessors have an 8-bit data bus, whereas 80286 processors have a 16-bit data bus. RISC, ARM and MIPS are microprocessors using the architecture of a reduced instruction set. 8051 and 8052 processors are widely used in a low cost application. 80286 processor can be used for higher speed/performance applications. RISC, ARM and MIPS processors are higher cost microprocessors better suited to more complex applications such as advanced ECC (Error Correction Code) and data encryption.

The optional power source 7 is mounted on the card body 1, and is connected to the processing unit 2 and other associated units on card body 1 for supplying needed electrical power thereto.

The optional function key set 8, which is mounted on the card body 1, is connected to the processing unit 2, and is operable so as to initiate operation of processing unit 2 in a selected one of the programming, reset, data retrieving, code updating, and data resetting modes. The function key set 8 is operable to provide an input password to the processing unit 2. The processing unit 2 compares the input password with the reference password stored in the flash memory device 3, and initiates authorized operation of electronic data flash card 10 upon verifying that the input password corresponds with the reference password.

The optional display unit 6 is mounted on the card body 1, and is connected to and controlled by the processing unit 2 for showing the data file exchanged with the host computer 9 and for displaying the operating status of the electronic data flash card 10.

The following are some of the advantages of the present invention: first, the electronic data flash card has a small volume but a large storage capability, thereby resulting in convenience during data transfer; and second, because everyone has a unique fingerprint, the electronic data flash card only permits authorized persons to access the data files stored therein, thereby resulting in enhanced security.

Additional features and advantages of embodiments of the present invention are set forth below.

FIG. 1(B) is a block diagram of an electronic data flash card 10A in accordance with an alternative embodiment of the present invention in which a generalized sensor unit 4A is provided in place of the fingerprint sensor described above. Exemplary sensor units include retina (eye) scanners or voice recognition devices that are capable of detecting a physical characteristic of an authorized user, and operates in a manner similar to that described above with reference to fingerprint sensor 4.

FIG. 1(C) shows processing unit 2A of FIG. 1(B) in additional detail. Electronic data flash card 10A includes a power regulator 22 for providing one or more power supplies. The power supplies provide different voltages to processing unit 2A and other associated units of electronic data flash card 10A according to the power requirements. Capacitors (not shown) may be required for power stability. Electronic data flash card 10A includes a reset circuit 23 for providing a reset signal to processing unit 2A. Upon power up, reset circuit 23 asserts a reset signal to all units. After internal voltages reach a stable level, the reset signal is then de-asserted, and resisters and capacitors (not shown) are provided for an adequate reset timing adjustment. Electronic data flash card 10A also includes a quartz crystal oscillator (not shown) to provide the fundamental frequency to a PLL within processing unit 2A. In accordance with an embodiment of the present invention, input/output interface circuit 5A, reset circuit 23, and power regulator 22 are integrated and/or partially integrated within processing unit 2A. A high integration substantially reduces the overall space needed, the complexity, and/or the cost of manufacturing. Compactness and reduced cost are key factors to removable devices such as the electronic data flash cards described herein. Modern IC (Integrated Circuits) packaging can integrate discrete IC components with different technologies and material into one IC package. For example, the input/output interface circuit is analog and digital mixed circuitry, which can be integrated into one MCP (Multi-Chip Package) with the processing unit. The reset circuit and power regulator are analog circuitry, which can also be integrated into the MCP with the processing unit. The nature of mixed signal IC technology allows the hybrid integration of both analog and digital circuitry. Therefore, a higher integration can be incorporated into the same chip/die for the processing unit which includes an input/output interface circuit, a flash memory controller, a reset circuit and a power regulator.

FIG. 1(D) is a block diagram of an electronic data flash card 10B in accordance with another embodiment of the present invention. Electronic data flash card 10B omits the fingerprint sensor and the associated user identification process. The electronic data flash card 10B also includes a highly integrated processing unit 2B including an input/output interface circuit 5B and a flash memory controller 21 for integration cost reduction reasons. Input/output interface circuit 5B includes a transceiver block, a serial interface engine block, data buffers, registers, and interrupt logic. Input/output interface circuit 5B is coupled to an internal bus to allow for various elements of input/output interface circuit 5B to communicate with the elements of flash memory controller 21. Flash memory controller 21 includes a microprocessor unit, a ROM, a RAM, flash memory controller logic, error correction code logic, and general purpose input/output (GPIO) logic. In one embodiment, the GPIO logic is coupled to a plurality of LEDs for status indication such as power good, read/write flash activity, etc., and other I/O devices. Flash memory controller 21 is coupled to one or more flash memory devices 3B.

Host computer 9B, which can either be a manufacture/test system or a user system, includes a function key set 8B, is connected to the processing unit 2B via an interface bus 15 when electronic data flash card 10B is in operation. When host computer 9B is a manufacture/test system, function key set 8B is used to selectively set electronic data flash card 10B in one of a formatting/testing mode and a code updating mode. When host computer 9B is a manufacture/test system, function key set 8B is used to selectively set electronic data flash card 10B in one of a data writing (programming) mode, a data retrieving mode, and data reset mode. The function key set 8B is also operable to provide an input password to the host computer 9B that facilitates either authorization to enter either the formatting/testing or code updating modes (i.e., entering a manufacturer-defined password), or authorization to access secure data (i.e., entering a user-defined password). The processing unit 2B compares the input password with the reference password stored in the flash memory device 3B, and initiates authorized operation of electronic data flash card 10B upon verifying that the input password corresponds with the reference password.

Host computer 9B includes display unit 6B, is connected to the processing unit 2B when is in operation via an interface bus or a card reader. Display unit 6B is used for showing the data file exchanged with the host computer 9B, and for showing the operating status of the electronic data flash card 10B. In addition, as explained in additional detail below, display unit 6B may be selectively controlled by electronic data flash card 10B to automatically display an advertisement or other message when electronic data flash card 10B is manually connected to host computer 9B.

In accordance with an embodiment of the present invention, processing unit 2B includes a flash memory type algorithm for detection if a flash memory type is supported by the flash memory controller logic. Flash memory controllers with such intelligent algorithms are disclosed, for example, in co-pending U.S. patent application Ser. No. 11/466,759, entitled FLASH MEMORY CONTROLLER FOR ELECTRONIC DATA FLASH CARD, which is incorporated herein by reference in its entirety.

The system architecture of a typical flash memory system includes a flash memory controller having a processor, ROM and RAM, in which the boot code and control code are residing in the ROM as ROM code. Upon power up, the processor fetches the boot code for execution, the boot code initializes the system components and loads the control code into the RAM. Once the control code is loaded into the RAM, it takes control of the system. The control code includes one or more drivers to perform basic tasks such as controlling and allocating memory, prioritizing the processing of instructions, controlling input and output ports etc. The control code also includes a flash type detection algorithm and flash memory parameters data. The ROM is a read only memory, after the flash memory controller design is done and moved into a production, the software code in ROM is frozen and cannot be changed to support new flash types released to the market in a later time. In such a situation, a new flash memory controller has to be developed to support new flash memories from time to time, which is costly and time consuming.

In accordance with another embodiment of the present invention, flash memory device 3B includes a reserved space 31 (i.e., a predetermined block of flash memory cells) that is used to store dynamic boot code 31A and control code 31B. At start-up, flash controller 21 utilizes static boot code stored in the controller's ROM to selectively read dynamic boot code 31A and control code 31B into main memory, and then flash controller 21 proceeds with boot and control operations in accordance with dynamic boot code 31A and control code 31B. By storing at least a portion of the boot code and control code used by flash controller 21 in reserved space 31, instead of in the flash memory controller ROM, the boot code and control code can be updated in the field without having to change the flash memory controller, and the size of the controller's ROM can be minimized. A flash card including boot code and control code stored in flash memory is disclosed, for example, in co-pending U.S. patent application Ser. No. 11/611,811, entitled FLASH MEMORY CONTROLLER FOR ELECTRONIC DATA FLASH CARD, filed Dec. 13, 2006, which is incorporated herein by reference in its entirety.

Also in accordance with the present invention, the flash memory cells of flash memory device 3B are partitioned using formatting techniques similar to those used for hard disk drives into two or more partitions that include at least one autorun partition 32 that is formatted using a file system that facilitates an Autorun function (e.g., CD-ROM file system (CDFS) or Universal File System (UFS)), and at least one disk partition 33 that is formatted using a typical data storage file system (e.g., 16-bit File Allocation Table (FAT16) file system, 32-bit File Allocation Table (FAT32) file system, or New Technology (NT) File System (NTFS)). Autorun partition 32 includes an Autorun.inf file 32A that is executed by flash controller 21 when electronic data flash card 10B is operably connected to host computer 9B via interface bus 15, and an application file 32B including one or more software applications executed in response to calls from the Autorun.inf file 32A. Further details regarding operation of the Autorun function are discussed below. Disk partition 33 includes data that is either public data 33A that is accessible without a user-defined password, or secured data 33B that requires a password to access.

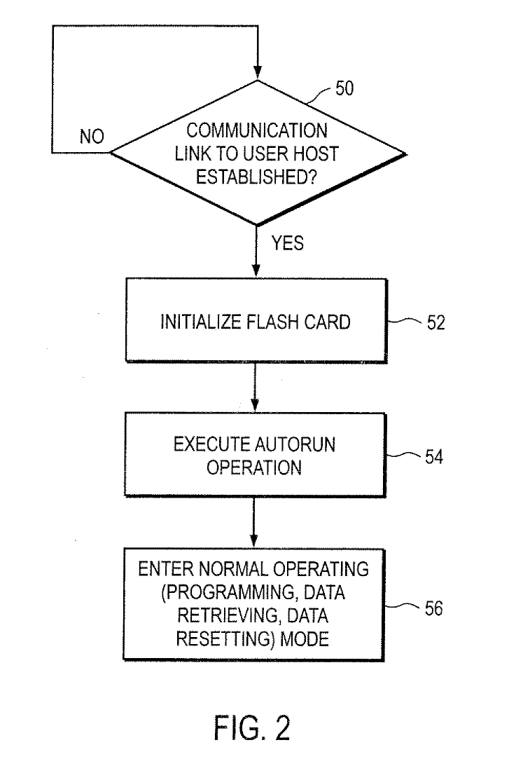

FIG. 2 is a flow diagram showing a simplified operation of electronic data flash card 10B according to an embodiment of the present invention. When the communication link between electronic data flash card 10B and host computer 9B is established (e.g., when electronic data flash card 10B is plugged into a USB socket on host computer 9B; YES branch is block 50), electronic data flash card 10B powers up and initializes system operations, and establishes a contact with host computer 9B (block 52). Next, in accordance with instructions provided in boot code 31A, flash memory controller 21 executes the commands stored in Autorun.inf file 32A (i.e., either executes software application 32B, or causes host computer 9B to execute software application 32B). After initiating (and in some cases entirely completing) the execution of software application 32B, flash memory controller 21 enters a “normal” operating mode in which a user is able to access data stored in disk partition 33, and/or write new data into disk partition 33 (e.g., operating in one of: a programming mode in which flash memory controller 21 activates input/output interface circuit 5B to receive a data file from host computer 9B, and stores the data file in disk partition 33; a data retrieving mode in which flash memory controller 21 reads the data file from disk partition 33, and activates input/output interface circuit 5B to transmit the data file to host computer 9B; and a data resetting mode in which flash memory controller 21 erases the data file from disk partition 33). By partitioning flash memory device 3B into two or more partitions that include both autorun partition 32 and disk partition 33, an embodiment of the present invention provides an enhanced electronic data flash card that facilitates operations that are not possible with a flash card having only a single partition. For example, electronic data flash card 10B may be distributed by a company without cost to users as a promotional item, and the autorun function may be used to play a predetermined advertisement on the user terminal's display each time electronic data flash card 10B is used. As set forth in additional detail below, electronic data flash cards manufactured in accordance with the present invention facilitate many other useful functions as well.

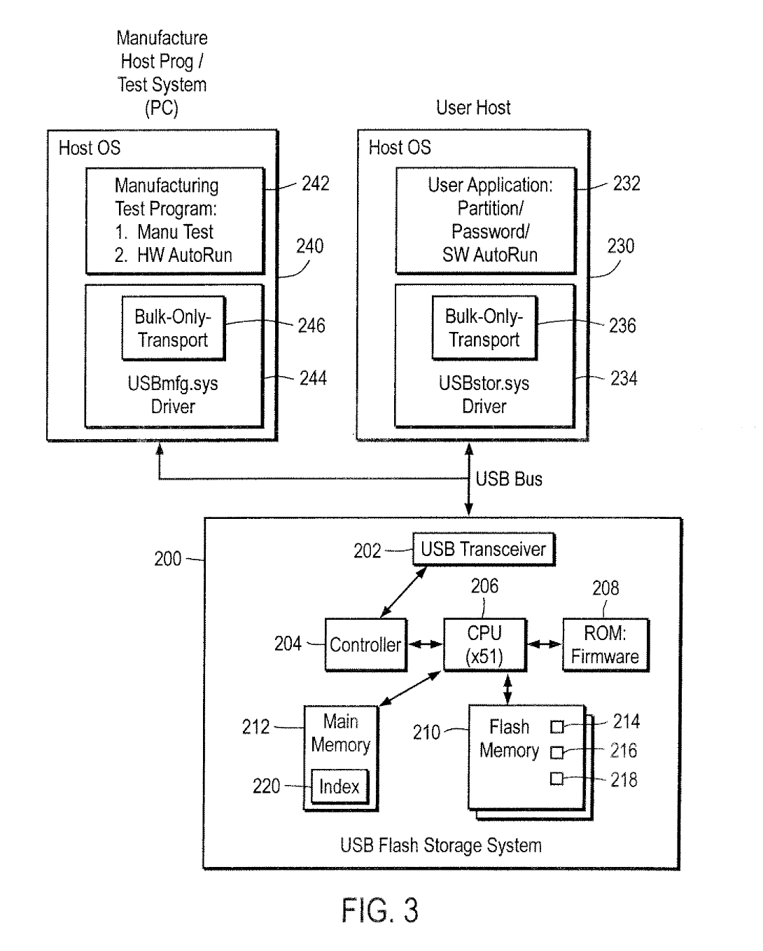

FIG. 3 is a block diagram of an electronic data flash card 200 in accordance with a specific embodiment of the present invention, which is referred to below as flash memory system 200. Flash memory system 200 includes a transceiver 202, a flash memory controller 204, a central processing unit (CPU) 206, a read-only memory (ROM) 208, a flash memory 210, and a main memory 212. In this specific embodiment, the transceiver 202 is a Universal Serial Bus (USB) transceiver. Note that the term flash memory represents one or more flash memory devices. Flash memory controller 204 is an embedded controller and handles most of the CPU commands that are provided by the firmware in the ROM 208 and/or stored in predefined sections of flash memory 210.

In accordance with the present invention, flash memory 210 is configured during an initial formatting/testing operation to include multiple partitions 214, 216, 218. The specific number of partitions will vary and will depend on the specific application. The flash memory system 200 utilizes the multiple partitions 214-218 to provide multiple functions. Access to the multiple partitions is provided by an index 220 in the main memory 212. The functions can include, for example, an AutoRun function, non-secured data storage, and secured data storage. Embodiments implementing the multiple partitions 214-218, the index 220, and these exemplary functions are described in detail below in the remaining figures.

During a normal operation, the flash memory system 200 is adapted to be coupled to a user host 230. The user host 230 can be a PC or Mac-based personal computer. The user host 230 includes a user application 232 and a driver 234 which executes a bulk-only-transport (BOT) protocol 236. In this specific embodiment, the driver 236 is a USB driver, and can be provided by an operating system such as Windows.

During a formatting/testing mode operation, the flash memory system 200 is adapted to be coupled to a manufacturer host 240. The manufacturer host 240 can be a personal computer (PC) having special programming hardware and software. In this specific embodiment, the manufacturer host 240 includes a manufacturing application 242 and a driver 244 which executes a BOT protocol 246. In this specific embodiment, the driver 246 is a USB driver.

The manufacturer host 240 formats and tests the flash memory system 200 before it is shipped to an end user. This formatting/testing operation enables the flash memory system 200 to create the multiple partitions 214, 216, and 218 and to execute multiple functions such as data storage and the AutoRun function. The driver 246 is a special driver (USBmfg.sys for example) which facilitates the programming process. The BOT protocol 246 commands facilitate in programming reserved areas of the flash memory 210.

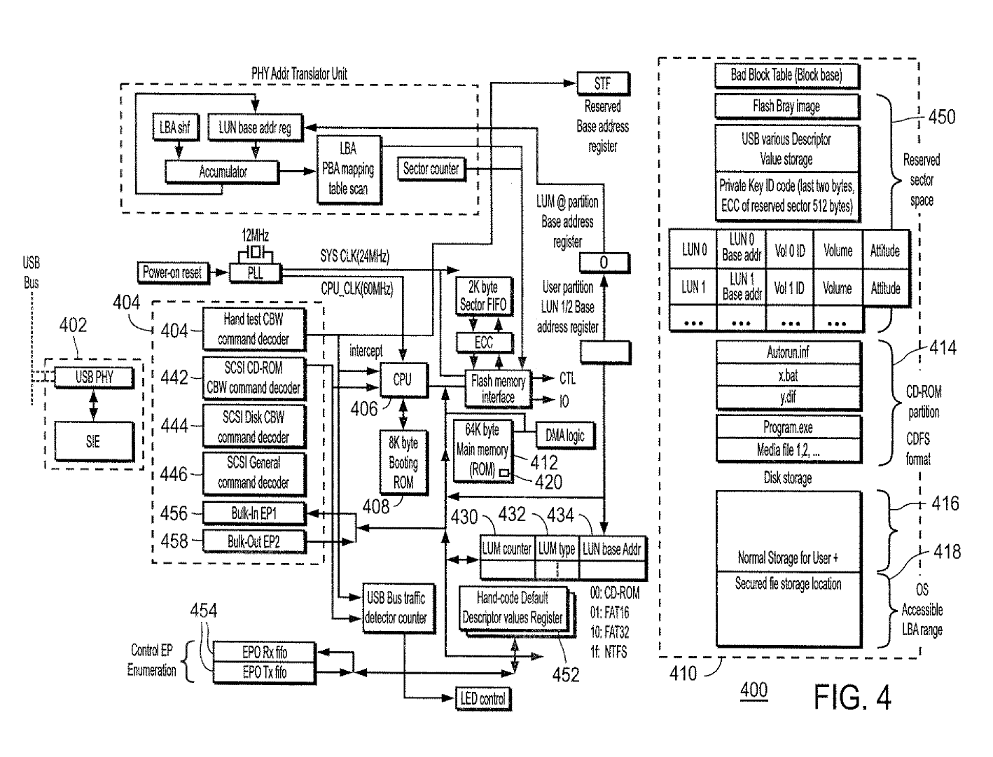

FIG. 4 is a detailed block diagram of a flash memory system 400, which can be used to implement the flash memory system 200 of FIG. 3 in accordance with a specific embodiment of the present invention. Generally, the flash memory system 400 includes a transceiver 402, a flash memory controller 404, a CPU 406, a ROM 408, a flash memory 410, and a main memory 412. The flash memory 410 is configured to include multiple partitions 414, 416, and 418. The main memory 412 stores an index or address translation table 420. The address translation table 420 stores information regarding the configuration of the flash memory 410 such as how many partitions it has and how the partitions are formatted (e.g. as a CD ROM, disk drive, etc.). The address translation table 420 also enables the CPU 406 to access the multiple partitions 414-418.

### Multiple Partitions

In accordance with one embodiment of the present invention, the partitions 414-418 have different file systems (e.g., structures or formats) that facilitate both the automatic execution of a manufacturer-defined Autorun operation and a “normal” (user-controlled) data access operation. Examples of various file structures are CD file structures (CDFSs), file allocation tables (FATs) such as FAT16 and FAT 32, and NT file structures (NTFSs). By having the multiple partitions 414-418 with different file structures, the flash memory system 400 can cause a host system to perform multiple functions. For example, one partition 414 (which may also be referred to as partition 0) can be formatted as a compact disk (CD) read-only memory (ROM) type partition, which uses a compact disk file system (CDFS) file structure. The CD ROM format enables the flash memory system to support an AutoRun function. The AutoRun function is described in more detail further below.

Another partition 416 (may also be referred to as partition 1) can be formatted as a disk partition. A disk partition can use different file structures (such as FAT16, FAT 32, or NTFS, etc.) and can be used for a typical flash memory usage (i.e. data storage). Being a disk type partition, this partition can be configured as a public partition, where it can be accessed without conditions (e.g. without a required password).

Another partition 418 (e.g. may also be referred to as partition 2) can also be formatted as a disk partition. In accordance with the present invention, a disk partition can be configured as a public partition or as a secured partition. If the disk partition is a secured partition, it can be accessed with a special utility program through a password. The secured partition is described in more detail further below. The types of partitions that can be used and the specific number of partitions will depend on the manufacturing specific application.

The flash memory system 400 also includes a logic unit number (LUN) counter 430, a LUN type register 432, and a LUN base address register 434. The flash memory controller 404 includes a manufacturer special command decoder 440, a small computer systems interface (SCSI) CD ROM dedicated command decoder 442, a SCSI fixed-disk type command decoder 444, and a SCSI general command decoder 446.

### Logic Unit Numbers (LUNs)

The address translation table 420 includes information regarding the configuration of the flash memory 410, and the CPU 406 can utilize the address translation table 420 to create and access the multiple partitions 414-418 in the flash memory 410. More specifically, in accordance with one embodiment of the present invention, the address translation table 420 associates LUNs with the respective partitions 414-418. A LUN is a unique identifier used on a SCSI bus to distinguish between devices that share the same bus.

In operation, the LUNs are used to identify each partition, and one LUN can correspond to one or more partitions. For example, one LUN can correspond to a CD ROM partition, which can be utilized for the AutoRun function. Another LUN can correspond to two disk-type partitions, which can be utilized for public and secured partitions. The number of LUNs and the types of partitions associated with each LUNs will vary and will depend on the specific implementation.

The LUN counter 430 resets and increments partition numbers. Each partition has a different type of removable or fixed storage function, volume capacity, and volume ID or drive letter. The LUN base address register 434 stores an address for each partition and a high order most significant bit (MSB) 3-bit value of total capacity. The LUN base address register 434 is a non-volatile register. Each particular partition corresponds to a LUN number, which can be determined by the manufacturing program.

A reserved area 450 stores 512 bytes of pre-programmed control information for the flash memory 410. The control information includes LUN numbers, LUN types, volume capacity, IDs, holding capacities of non-volatile registers, partition information, etc. In a specific embodiment, the holding capacities of non-volatile registers and each partition information are stored in the first available address space of the reserved area 450. Typically, the information in the reserved area 450 needs to be programmed at a manufacturing site for an initial setup or later re-programmed for recall purposes or for firmware updates. In a specific embodiment, up to four copies (for purposes such as copying, backup, etc.) of the control information in the reserved area are preserved to facilitate erase-before-write operations of the flash memory. A “reserved space ratio,” which is the amount of reserved flash memory space relative to the capacity of the flash memory, is determined by the manufacturer.

A CD ROM-base zone follows the reserved area 450 in the flash memory. The memory space dedicated to different function blocks can be referred to as zones. The reserved area can have one zone number (e.g. 000) and the CD ROM related address can have another zone number (e.g. 001, if the reserve space occupies only one zone). As disk storage zone requires frequent reads and writes, certain zone numbers associated with the final physical address spaces initially can be dedicated for wear leveling. However, wear leveling blocks can be later relocated anywhere except the reserved zones and CD-ROM zone.

Hard-coded registers 452 are used to respond back to the user host, especially when the flash memory is non-programmed (totally empty), so that a default value in the enumeration descriptor is sent back to the user host. If the flash memory system 400 is already programmed, a programmed value in the enumeration descriptor is sent back instead of a default value.

The architecture of the flash memory system 400 utilizes bulk-only-transport protocols and a command block wrapper (CBW) having 31 bytes of control information. A manufacturing command (e.g. F1, F2, etc., those specially coded command not listed in SCSI command manual) or a general purpose command block wrapper command block (CBWCB) (such as an SCSI inquiry command), and a dedicated Request-LUN-Number command (e.g. 43h command code) are decoded and passed to the flash memory controller 404 for proper operation of the flash memory system 400.

An endpoint 0 (EP0) 454 is dedicated to the enumeration process, and a packet size (e.g. 64 bytes) is programmed in a device descriptor field for information transfers.

The endpoint 1 (EP1) 456 is a bulk-in pipe for a host to read data from the flash memory system. The endpoint 2 (EP2) 458 is a bulk-out pipe for a host to send data to the flash memory system. The sizes (e.g. 64 bytes for USB version 1.1, and 512 bytes for USB version 2.0) of the EP1 456 and the EP2 458 can vary and will depend on the specific application.

### Translation Table

### FIRST EMBODIMENT

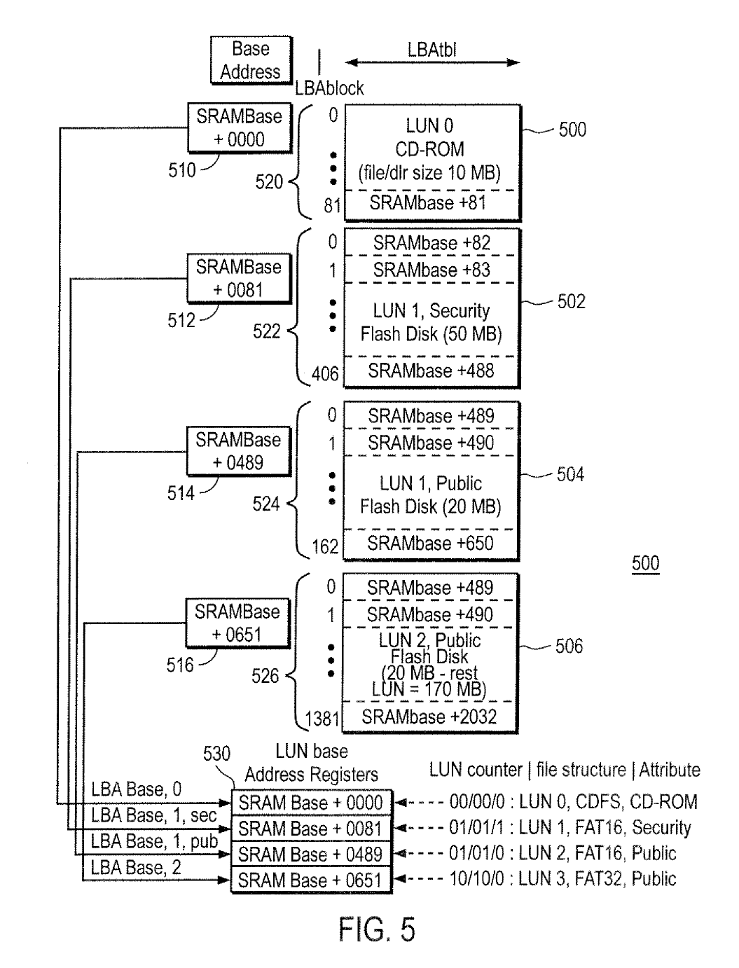

FIG. 5 is an example of translation table 500 of four partitions, which can be used to implement the index 220 of FIG. 3 or the address translation table 420 of FIG. 4, in accordance with the present invention. The translation table includes LUNs 500, 502, 504, and 506. The LUNs 500, 502, 504, and 506 are also referred to as LUN 0, LUN 1, LUN 2, LUN 3, respectively. In a specific embodiment, the CD ROM partition is assigned to the LUN0 500. The LUN0 500 is given the highest priority by the Windows operating system (OS) and will show a lower drive letter. The LUNs 502 to 506 are each assigned to separate partitions. The partition associated with the LUN 502 is password protected, and the partition associated with the LUN 504 and 506 are public, i.e. available for general access. In this example two public partitions are useful for data organizations.

In operation, the address translation table 420 maps the LUNs 500-506 and the LBAs from the host to the PBAs. The LUNs 500, 502, 504, and 506 are associated with respective SRAM base addresses 510, 512, 514, and 516, respectively, and associated with respective LBA_{blk} 520, 522, 524, and 526, respectively. Generally, the LUNs 500-506 and LBA_{blk} 520-526 are used by flash device firmware to calculate PBAs. The LBA_{blk} 520-526 are added to the respective base address value stored in LUN base address registers 530. Adding an LBA_{blk} 520-526 to a base address 510-516 provides a unique value for address translation. The unique value is a PBA, which reflects a flash memory physical address for controller access. A method for calculating the LBA_{blk} is discussed below in the following section.

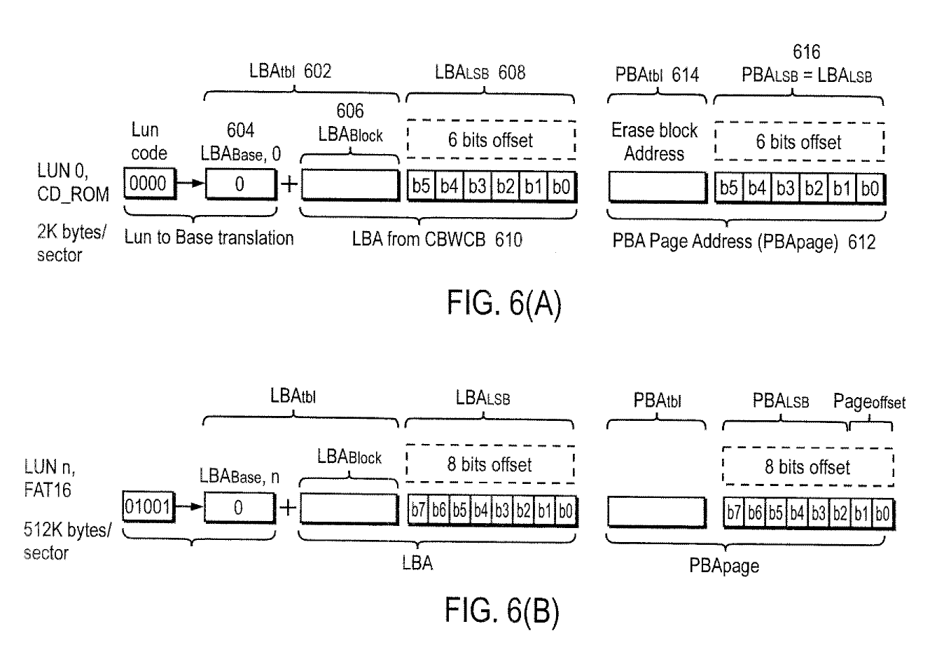

FIGS. 6(A) and 6(B) are exemplary applications of the address translation table 500 of FIG. 5 in accordance with one embodiment of the present invention. The flash memory in this example is 256 Mega bits total capacity, which is organized as 2K bytes per page, and 64 pages per erasable block. FIG. 6(A) is applied to a partition that is formatted as a CD ROM partition (i.e. 2K bytes per CD-ROM sector), and FIG. 6(B) is applied to a partition that is formatted as a disk partition (i.e. 512 bytes per disk sector). Generally, the LUNs and LBAs are used by flash device firmware to calculate PBAs for physical block address access.

Referring to FIG. 6(A), the value in the LBA column 602 (LBA_{tbl}) is formed by summing an LBA base address 604 and an LBA_{blk} address 606. The LBA base address 604 is the same as the LUN base address. The LBA_{blk} address 606 is a value derived from an LBA provided by the CBWCB 610 by LBA_{LSB} 608 (i.e. right shifting a particular number of bits). In this example, it is shifted by six bits in the case of an erasable block having 64 pages. A PBA page address 612, which has 2K bytes per page, is formed by two components, a PBA_{tbl} 614 (a mapping result of the translation table) and a 6-bit offset 616. The PBA_{tbl} table address 614 is the mapping result of the translation table 420 (FIG. 4) from the index of the LBA_{tbl} 602. The offset 616 is provided by the lower six bits (LSBs) of the LBA from the CBWCB 610. In this case, the 6-bit PBA least significant bit (PBA_{LSB})=6-bit LBA_{LSB} 608.

Referring to FIG. 6(B), the values are derived similarly to those in FIG. 6(A) except that the offset value LBA_{LSB} is 8 bits (due to 512 bytes per sector out of 2K bytes per page of flash memory). The six MSBs of the LBA_{LSB} are concatenated with the PBA_{tbl} to construct the PBA address for the flash memory. The two LSBs of the LBA_{LSB} are used to access 512 bytes out of the 2K-page flash. In this case, 6-bit PBA_{LSB} equals 6-bit MSB from 8-bit LBA_{LSB}.

In accordance with one embodiment of the present invention, a flash memory can have different size formats such as a small format and/or a large format. The small format has a sector size of 512 bytes per page and 16K bytes per erase block. The large format has a sector size of 2K per page and 128K bytes per erase block. The specific sizes will vary and will depend on a specific implementation. The following is an example of a large format flash translation SRAM.

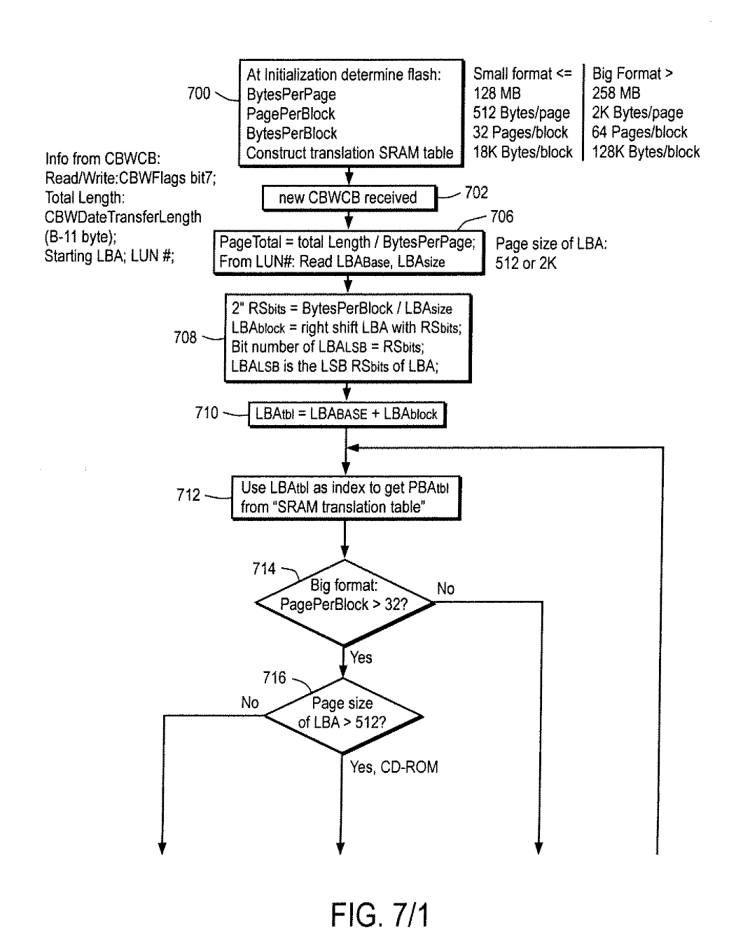

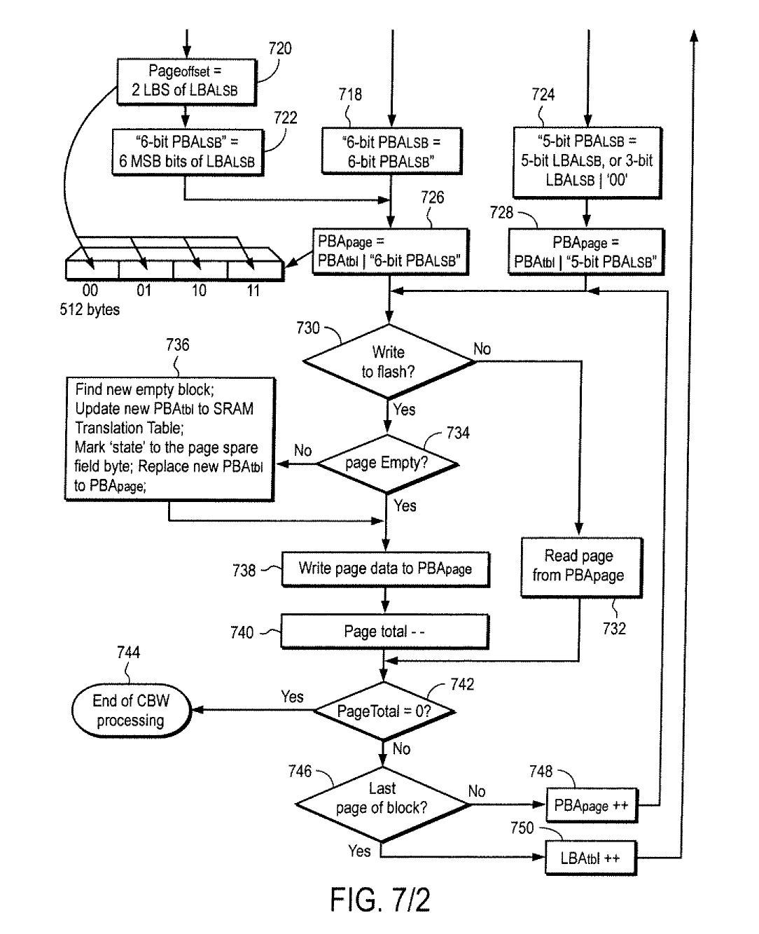

FIG. 7 is a flow chart showing a method for providing the translation table 500 of FIG. 5 in accordance with one embodiment of the present invention. First, the flash memory system is initialized, in a step 700. The flash memory controller determines the type of flash memory that is in the flash memory system, whether the flash memory has a small format or large format, and determines values for the number of bytes per page, pages per block, and bytes per block.

The flash memory controller also reconstructs the translation table 420 from the flash memory. The device controller reads each first page of each erase block using the physical address from the beginning block to the last. On each read, the device controller reads the block-related information (such as LBA_{tbl}) stored in the spare area next to the data area, which has 2K bytes (or 512 bytes). The device controller then uses the valid LBA_{tbl} as an index to the address translation table 420 and stores a corresponding PBA.

Next, a new CBWCB is received and its information is extracted by the device controller, in a step 702. Such information can include, for example, the total transfer length of bytes requested, whether the command is a read or write command, the LUN number, the starting LBA address, etc.

Next, a base address value LBA_{base} and base address size LBA_{size} is determined based on the LUN number, in a step 706. The total page size (Page Total) is calculated by dividing the total length by the number of bytes per page. Next, an RS_{bits} value is calculated based on the number of bytes per block and the page size of the LBA, in a step 708. The RS_{bits} values are used to calculate values of the LBA_{block} (by right shifting the LBA by RS_{bits}), and are used to calculate the LBA_{LSB} (RS_{bits} bits of the lower LBA).

Next, an index of LBA_{tbl} for the translation table is calculated, in a step 710. Next, the PBA is calculated from the contents of the translation table, in a step 712.

Next, it is determined whether the flash memory is a large or small format, in step 714. If the flash memory is small format (512 bytes per page), the device controller needs a 5-bit PBA_{LSB} as the page offset address, in a step 724. The 5-bit PBA_{LSB} will be equal to a 5-bit LBA_{LSB}, or equal to a 3-bit LBA_{LSB} concatenated with two “0”s at the right, depending on the page size of the LBA. In the case where the flash memory is a large format (2K bytes per page), it is then determined that the LBA page size is greater than 512 bytes or equal to 512 bytes, in a step 716. If it is greater than 512 bytes, the 6-bit PBA_{LSB} value will be equal to the 6-bit LBA_{LSB} value, in a step 718. If less than 512 bytes, the page offset value will be equal to the 2 LSBs bits of the LBA_{LSB}, in a step 720, and the 6-bit PBA_{LSB} is equal to 6 most significant bit (MSB) bits of the LBA_{LSB}, in a step 722. The flash memory controller needs a 6-bit PBA_{LSB} as the page offset address. The 6-bit PBA_{LSB} will be equal to 6-bit LBA_{LSB} or 6 higher bits of 8-bit LBA_{LSB}, depending on the file format sector size of the LBA. Next, the 2 lower bits of an 8-bit LBA_{LSB} is offset, in a step 726.

Next, it is determined if the flash memory access is a read operation or a write operation, in a step 730. If the operation is a read operation, data is read from the PBA page, in a step 732. If it is a write operation, it is determined whether the address or the page is already occupied, in a step 734. If it is occupied, a new empty block is found and updated with the new PBA value to address translation table, in a step 736. As such, a new PBA page is calculated based on the new PBA_{tbl}. If the page is unoccupied, data is written to the PBA page, in a step 738.

Next, the value for the Page Total defined in 706 is decrement by 1, in a step 740. Next, it is determined whether it is the last page of Page Total, in a step 742. If so, the CBWCB process ends, in a step 744. Otherwise, it is determined whether it is the last page of the block, in a step 746. If not, the PBA page is incremented by 1, in a step 748, and the process repeats, beginning at the step 730. If it is determined to be the last page of the block, in the step 746, the LBA_{tbl} is incremented by 1, in a step 750, and the process repeats at the step 712.

Although the index described above has been implemented with a translation table having an absolute addressing scheme, one of ordinary skill in the art will readily realize that the index can be implemented using other schemes and still remain within the spirit and scope of the present invention.

### Translation Table

### SECOND EMBODIMENT

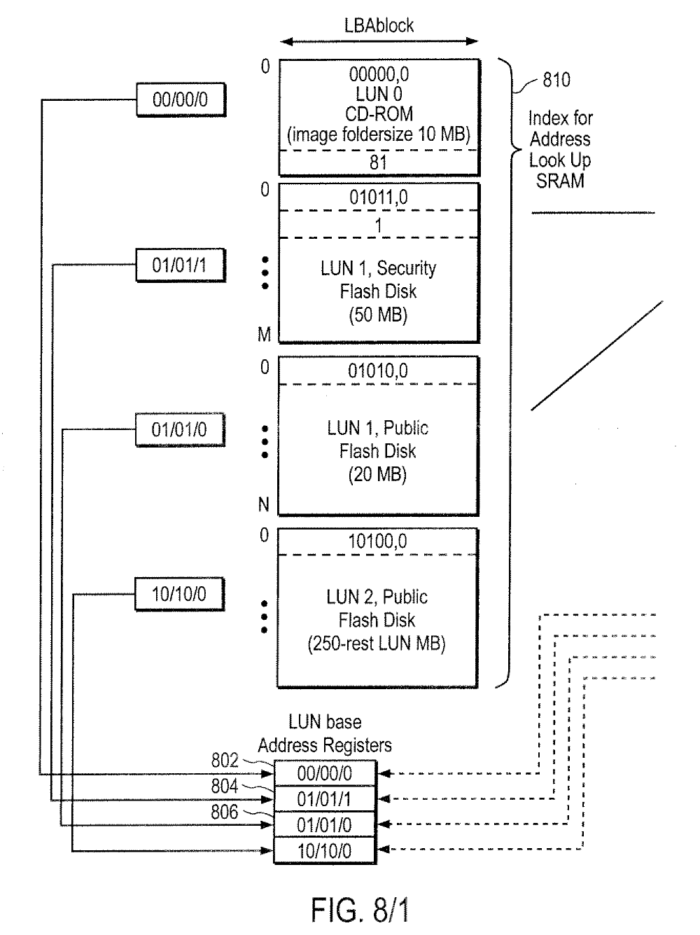

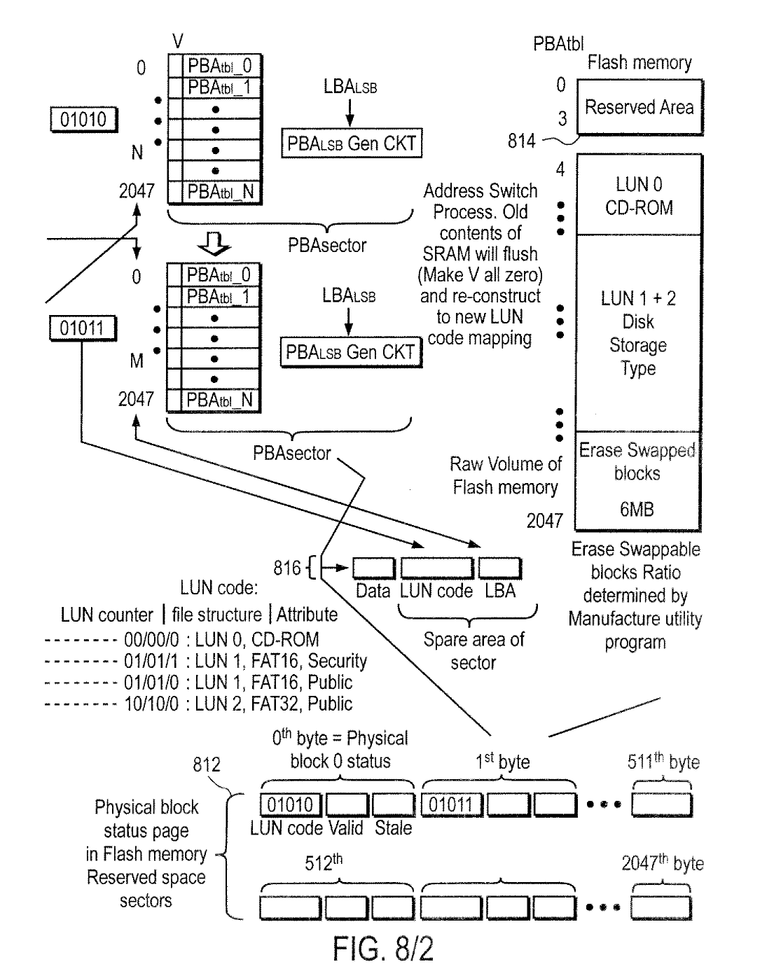

FIG. 8 is a translation table in accordance with another embodiment of the present invention. Each LUN has associated LUN code, which is a LUN counter value cascaded with a file structure, and an attribute. For example, a first LUN base address register 802 stores values for the LUN 0 (associated with a CD ROM partition) has a LUN counter value of 0, a CDFS file structure, a 00 type file system type, a public attribute, results in 00/00/0 code. A second LUN base address register 804 stores values for the LUN 1 (associated with a security partition) has a LUN counter value of 1, a FAT 16 file structure, a 01 type file system type, a security attribute, results in 01/01/1 code. A third LUN base address register 806 stores values for another LUN 1 can also be associated with a public partition. As such, the LUN 1 has a LUN counter value of 1, a FAT 16 file structure, a 01 type file system type, a public attribute, and results in 01/01/0 code.

Generally, the LUN code is used to concatenate with LBAs and to generate corresponding PBAs. For different LUN numbers, the operating system (OS) can generate the same LBA value to access data. A single SRAM look up table can be dedicated for all LUNs. However, when the LUN changes, a reconstruction process is used to rebuild the address translation table in the SRAM device for later OS access. An index 810, which is for the translation table, consists of LUN code concatenated with the LBA. The content of the translation table provides PBA_{tbl} values. The maximum index number in this example is 2048 (i.e. 256 Mbits flash memory). A copy of every physical block status page 812, which includes LUN code as well as valid states, is stored in flash reserved area 814 for a firmware statistics usage. Each page per block 816 of flash physical memory consists of data and spare areas. The spare area includes LUN code and LBA information from the host.

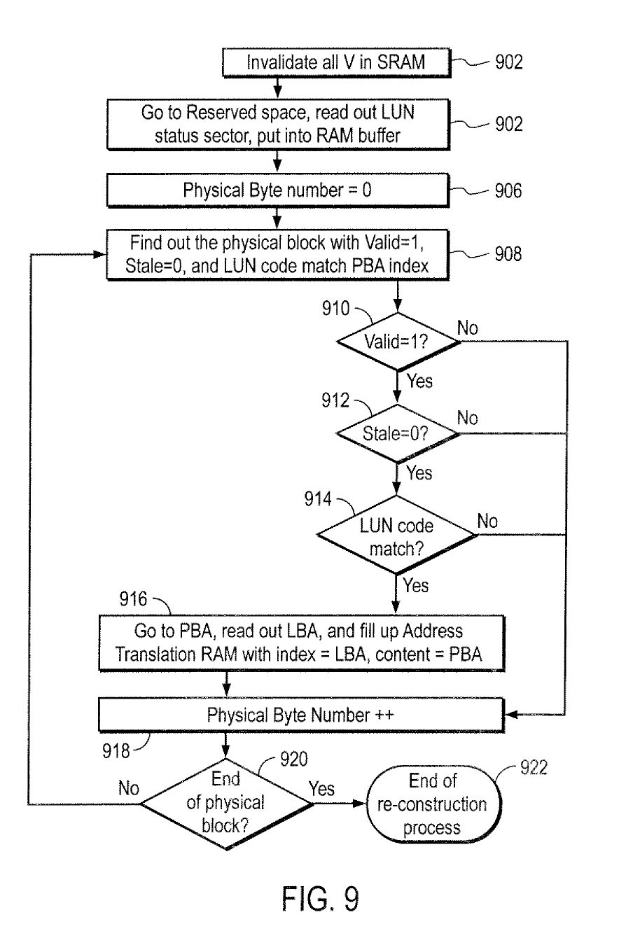

FIG. 9 is a flow chart showing a method for constructing the translation 800 table of FIG. 8 in accordance with one embodiment of the present invention. Generally, referring to both FIGS. 8 and 9 together, if the LUN changes, the contents of the translation table are flushed for each access, and then the translation table is reconstructed.

More specifically, first, in a step 904, the valid flags of all entries are invalidated during a LUN change process. Invalidating the valid flags flushes the translation table. Next, in a step 904, the contents of the physical block status page 812 (FIG. 8) is read from the reserved area 814 in the flash memory. The contents of the physical block status page 812 are then stored in a translation table. The LUN status sector consists of 2 k bytes for 256 MB flash (with 64 pages per block) for example, and each byte represents an associated physical block status (LUN code, valid flag, and stale flag). This is one time that the sector read operation occurs during a LUN change. A 0th byte is linked to a physical block address #0. Only a valid flag set (equals one) and matched LUN code will indicate a valid block status. Stale flag means the block data is out-dated which requires recycling to reclaim the validity.

Next, in a step 906, a physical byte number in the physical block status sector is read sequentially. The physical block status sector has all of the required physical block information (e.g. LUN code, valid flags, stale flags). Next, it is determined whether the physical block fulfills valid download requirements, in a step 908. If yes, it is determined if the valid flag matches, in a step 910, if the stale flag matches a non-stale state, in a step 912, and if the LUN code matches, in a step 914. If yes to all of the steps 910-914, in the flash memory the PBA is used determine the LBA, and then both the PBA and the LBA are used to reconstruct the translation table, in a step 916. Next, the physical byte number is incremented, in a step 918. If either the valid flag, non-stale flag, or the LUN code does not match, the physical byte number is incremented without updating the translation table, in the step 918. The physical block ends, in a step 920, and reconstruction of the new translation table completes, in a step 922. The process returns to the step 908 if the end of the physical block status page 812 has not been reached. This method can support a multiple LUN structure and share a single translation table. Hence, this method can support more OS types and is not limited to the Windows OS.

### Manufacturer Utility Programming

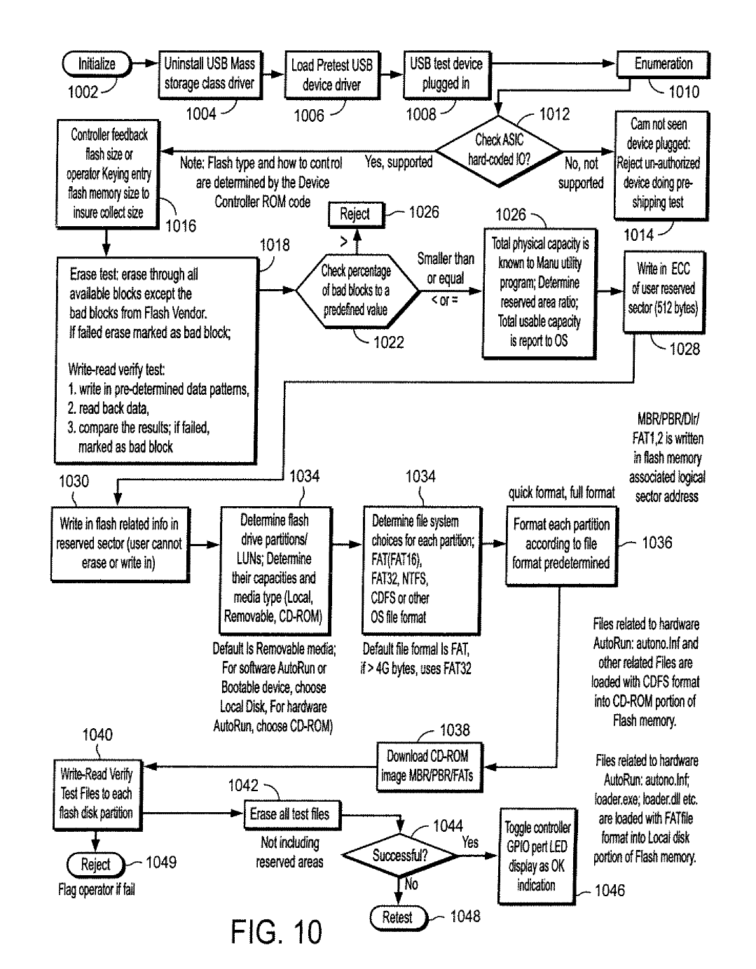

FIG. 10 is a flow chart showing a method for programming a flash memory system 400 of FIG. 4 in accordance with the present invention. The flash memory system 400 is formatted before being shipped to an end-user. A manufacturer utility program which is used to program the flash memory system 400 uses special software drivers. Once the flash memory system 400 is programmed, the end user cannot change basic structure even by formatting the flash memory system 400 using an operating system such as Windows OS.

First the manufacturer host is initialized, in a step 1002. Next, a USB mass storage class driver is uninstalled, in a step 1004. Next, a pretest USB driver is loaded, in a step 1006. The pretest USB driver support special manufacturing commands. Next, the flash memory system is connected to the manufacturer host, in a step 1008. Next, an enumeration process is executed, in a step 1010. Next, a partial variable enumeration descriptor field value, which is custom made for each flash memory, is loaded. For example, the serial number of each flash memory has to be unique for each mass storage class driver needed. Also, the product ID and version number is provided each time the firmware code is updated.

Next, an ASIC hard-coded ID in the flash memory system is checked, in a step 1012. If the ASIC hard-coded ID does not match, the flash memory system is rejected by utility software, in a step 1014. If the ASIC hard-coded ID matches, the ROM firmware in the flash memory system identifies the flash memory type and capacity, and then sends this information to the manufacturer host, in a step 1016. Alternatively, this information can be entered into the manufacturer host manually.

Next the data in the flash memory is erased and pre-assigned patterns are written to the flash memory, in a step 1018. In a specific embodiment, only blocks with good flags are erased. Blocks that fail to erase or that cannot be written to correctly are marked as bad blocks and these blocks are recorded in a bad block table in the reserved area of the flash memory.

Next, the percentage of bad blocks are checked, in a step 1022. This percentage is compared to a predetermined value that is either pre-programmed or manually keyed-in, in step 1022. If the percentage is greater than the predetermined value, the flash memory system is rejected, in a step 1024. Next, if the percentage is less than or equal to the predetermined value, the total physical capacity of the flash memory and a reserved ratio is determined, in a step 1026. Next, error correction code (ECC) (e.g. checksum of reserved sector codes) is written in dedicated physical address of the flash memory using special manufacturing commands, in a step 1028. Firmware in the flash memory controller checks the ECC each time reserved sector codes are updated to another empty reserve space, and an outdated copy is erased.

Next, flash related information is written into the reserved area, in a step 1030. Run-time code is part of the booting processes. Any codes that are not directly involved with the initial booting of the controller are put into the flash memory device to reduce the ROM size of the device controller. Enumeration field programmed values (e.g. serial number and product version number) as well as some partition (volume) sizes are loaded in at the same time. Some special loading commands can be recognized by the flash memory controller and load values in the flash reserved areas which the user cannot modify or erase. A device embedded controller ASIC ID and the write-in special password code is checked when the reserved area is accessed. Run-time code is loaded to the reserved area. The code can be updated if any bugs are found or if newer versions are available. Also, a notice to a manufacturer operator may be indicated using an LED as to whether a tested device tests okay or not.

Next, flash drive partitions, capacities, media types, and LUNs are determined, in a step 1032. Specifically, the number of partitions is determined along with the capacity, media type, and associated LUNs for each partition. Each LUN can be or have different capacities, media types, and LUN numbers. Once the partition number is determined by the manufacture utility program, a user can not change back or alter the numbers.

Next, file system formats for each partition are determined, in a step 1034. Such file system formats include CDFS, FAT16, FAT 32, NTFS, etc. Next, each partition is formatted according to the file system determined in the step 1036. For each partition, a partition table, partition type, and total capacity are loaded by the manufacturer host OS, in a step 1036. Such information is required for the files in the partitions to be recognized. The device is formatted according to a desired file structure determined by the manufacturer operator. For example, FAT16/32/NTFS is very common to PC users. Each choice may depend on device volume supported, and if the size is larger than 1 G byte, FAT32 will be best choice for this device as FAT16 no longer fits. The partition block record (PBR), 2 copies of the FAT, and the root directory are preloaded for the end users, in a step 1038.

Next, a final write-read test is performed, in a step 1040. During this test, the allowable storage portions of the partitions are written to and read to ensure that they function properly. Any corrupted file structures are also tested to guarantee user storage safety. Any failures get flagged, in a step 1040.

Next, the allowable storage portions of the partitions are erased to an empty state, in a step 1042. Next it is determined if the entire process was successful, in a step 1044. If successful, an LED display indicates so with a particular flashing pattern, in a step 1046. The LED display is connected to a general purpose I/O port. Any untested flash memory system will show a different flashing pattern (or no pattern) when plugged in the manufacturer host, in a step 1048. This indicates whether a flash memory system has been programmed and tested.

### Autorun Function

Configuring a CD ROM partition to the flash memory device enables it to support the AutoRun function. AutoRun is an operating system feature that enables associated files to automatically open a document or execute an application when a CD is inserted in a CD ROM drive of a computer. For example, when a user inserts a CD into a CD ROM drive, the AutoRun function enables the CD to automatically start an installation program or a menu screen. The AutoRun function is typically seen during a software installation when a Windows OS disk or CD ROM is inserted into a computer system.

In accordance with one embodiment of the present invention, the AutoRun function is implemented by a combination of configuring an extra partition of flash memory with firmware and hardware support to emulate the Window system CD-ROM feature.

### Enumeration

The Windows OS can support the AutoRun function using a partition that is either a CD ROM-type partition, or a fixed-disk partition (typically used for hard disk drives or ZIP drives). In one embodiment of the present invention, the AutoRun function is implemented using a partition that is a CD ROM-type partition, as describe above. As such, the enumeration is modified so that it informs the OS that the flash memory device is not a removable device but is instead a CD-ROM device. Also, the ROM code in the flash memory controller is modified so that the ROM code supports the AutoRun function.

In an alternative embodiment of the present invention, the AutoRun function can be implemented using a partition that is a fixed-disk partition. As such, the partition associated with the AutoRun function is formatted as a fixed disk. This may be referred to as a software implementation, since the software for the AutoRun function can run without having to make any hardware changes to the flash memory system. However, files related to the AutoRun feature can be deleted if the AutoRun files are stored in a fixed-disk partition, but it cannot be deleted if the AutoRun file are stored in a CD-ROM partition.

### Advertising Feature

As described above, the AutoRun function is utilized to automatically execute a software program. In a specific embodiment, the software program can provide advertising. For example, when the flash memory system is plugged into a user host, the AutoRun function can automatically execute a software program that delivers an advertisement via the host. The advertisement can be visual using a monitor attached to the user host. The advertisement can also be auditory using speakers attached to the user host. The specific mode of advertisement will vary and will depend on the specific application. The advertising feature can also be configured such that the end user cannot erase advertising materials themselves.

### Testing Software Feature

Computer diagnostic software can be implemented by the AutoRun feature. A benefit of this is that the software image can be protected not allowing the software image to be reverse engineered. Also, the AutoRun function is user friendly because test functions of the computer diagnostic software can be automatically executed. A floppy disk can serve a similar function but without the image protection.

### Keying Feature

Keying software can be implemented using the AutoRun feature, where the keying software program provides privileges for accessing the host system. For example, if the flash memory device is plugged into the USB port, the AutoRun feature automatically executes a keying software in the host system to facilitate access to information (data) stored on the host computer system. If the user unplugs the flash memory device from the USB port, the host system will be locked.

### User Profile Feature

User profile software can be implemented using the AutoRun feature, where the user profile software provides user profile information (system settings) associated with each application. For example, the user profile information can include user-customized settings for internet browser options (e.g. bookmarks, default home page), email settings, Word settings, etc.

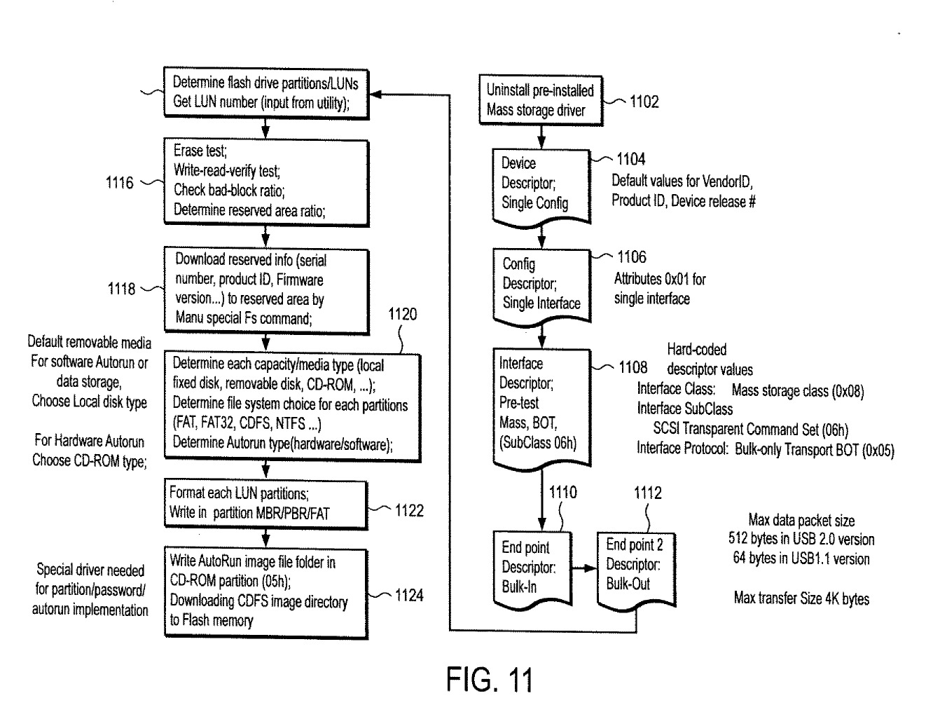

FIG. 11 is a flow chart showing a method for setting-up an AutoRun function with a manufacture host in accordance with the present invention. Before the manufacturer utility program starts, the old mass storage driver is uninstalled, in a step 1102. Next, a device descriptor is set to a single configuration, in a step 1104. Next, a configuration descriptor is set to a single interface, in a step 1106. Next, interface descriptors are set, in a step 1108. These descriptors include an interface class (e.g. mass storage class), interface subclass (e.g. SCSI transparent command set), and interface protocol (e.g. bulk-only transport BOT). Next, a first endpoint descriptor (i.e. bulk-in) is set, in a step 1110. Next, a second endpoint descriptor (i.e. bulk-out) is set, in a step 1112. These two endpoints are needed to implement bulk-in and bulk-out operations. Next, the partitions and LUNs are determined, in a step 1114. After enumeration is completed, a mass storage class request (e.g. get-max-LUN command) is issued to the flash memory system, and a default number of LUNs is returned. Alternatively, an operator manually enters information using a manual test utility program.

Next, an erase test and a write-read test are executed, and bad-block and reserved area ratios are determined, in a step 1116. Next, reserved information is downloaded into the flash memory, in a step 1118. Reserved information includes a serial number, a vendor, a product ID, a firmware version, etc. This information is available for access by an OS driver during enumeration process in normal operation mode. Information such as a mass storage class, BOT, and SCSI subclass are returned to the manufacturer host.

Next, the partition capacities, media types, file system types, and AutoRun types are determined, in a step 1120. A utility program issues a special command (i.e. F0h) to increment counters after each LUN partition recording file structure information in the flash memory. The partition information is saved in the flash memory reserved space for future user reference. File structure information such as master block record (MBR), partition block record (PBR), FATs per partition must be pre-programmed and saved in an OS accessible area.

To enable the CD ROM AutoRun function, all executive files must be stored in a CDFS format. The access method for a CD ROM file is different from that for a disk storage file. Next, each LUN partition is formatted, in a step 1122. Next, a CDFS image directory is downloaded to the flash memory together with AutoRun image files to the CD ROM partition, in a step 1124.

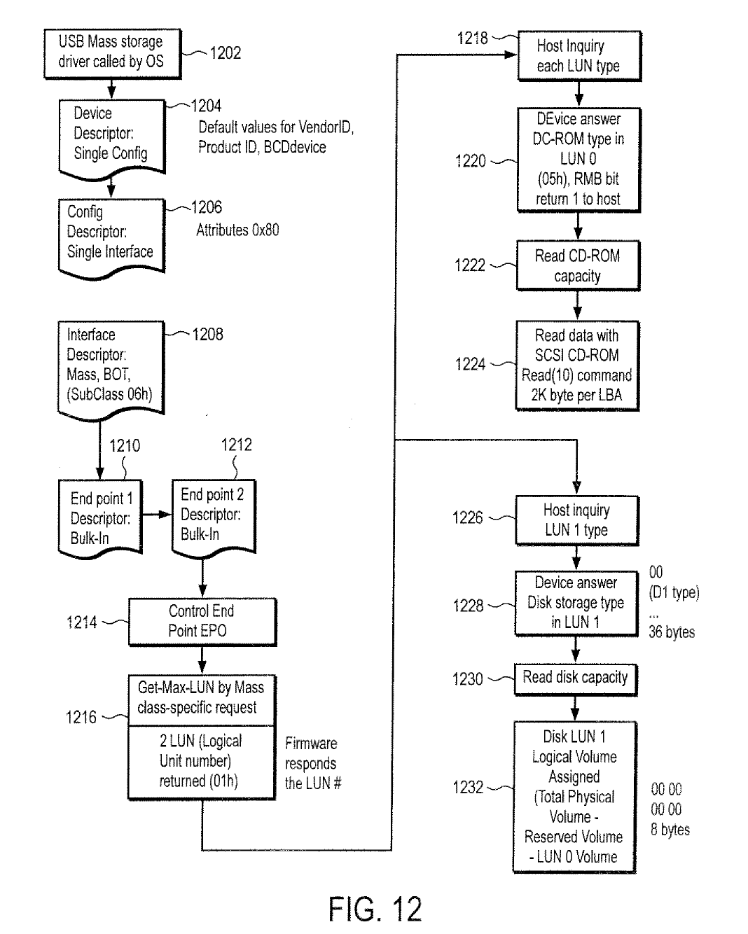

FIG. 12 is a flow chart showing a method for running an AutoRun function during a user mode in accordance with one embodiment of the present invention. When a user plugs the flash memory system into a user host, the USB mass storage driver is executed by the OS, in a step 1202. Next, a device descriptor is set to a single configuration, in a step 1204. Next, a configuration descriptor is set to a single interface, in a step 1206. Next, interface descriptors are set, in a step 1208. These descriptors include an interface class (e.g. mass storage class), an interface subclass (e.g. SCSI transparent command set), and an interface protocol (e.g. bulk-only transport). Next, a first endpoint descriptor (i.e. bulk-in) is set, in a step 1210. Next, a second endpoint descriptor (i.e. bulk-out) is set, in a step 1212. Next, a control endpoint (EP0) is set, in a step 1214. Next, the maximum LUN is retrieved, in a step 1216, and 2 LUNs is assumed in this example.

The following steps involve a CD ROM partition. After the step 1216, if a CD ROM partition is involved, the user host requests the LUN type for the CD ROM partition, in a step 1218. Next, the LUN types are sent to the user host, in a step 1220. Next, once the LUN for the CD ROM partition is confirmed, the CD ROM capacity is read, in a step 1222. Next, data is read with a SCSI CD ROM read command, in a step 1224.

The following steps involve disk partitions other than a CD ROM partition. After the step 1216, if a disk partition other than a CD ROM partition is involved, the user host requests the LUN type for disk partitions, in a step 1226. Next, the LUN types are sent to the user host, in a step 1228. Next, once the LUN type for the disk partition is confirmed, the disk partition storage capacity is read, in a step 1230. Next, a volume is assigned by user host operating system, in a step 1232.

Enumeration reads out string values stored in flash memory reserved space. Since the AutoRun function is enabled by the CD ROM partition, the pre-stored image will be executed automatically. At the same time the AutoRun feature is executed, the normal disk type storage function is enabled for the user.

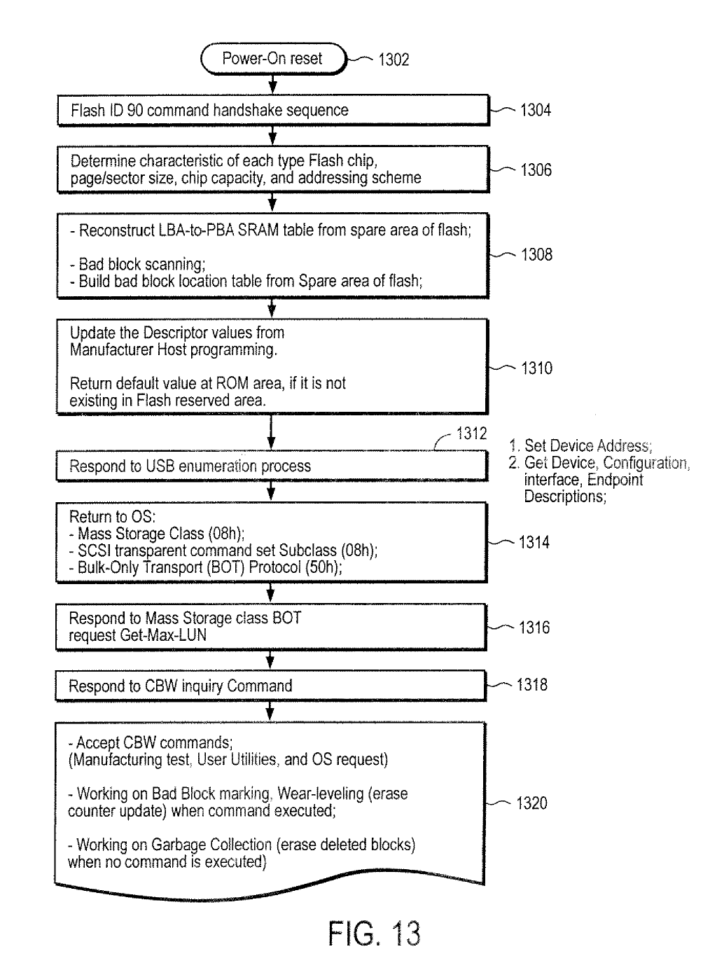

FIG. 13 is a flow chart showing a method for booting up a ROM of the flash memory device in accordance with the present invention. First, a power-on reset operation is initiated, in a step 1302. Next, a flash ID handshake sequence (i.e. Flash memory chip address 90h read command) is executed, in a step 1304. Next, characteristics of each flash memory chip are determined, in a step 1306. Such information includes page/sector size, chip capacity, addressing schemes, etc. A flash device running code image file is fetched from the reserved area.

Next, an LBA-to-PBA table is reconstructed using information in the reserved area, in a step 1308. Next, descriptor values are updated, in a step 1310. Next, an enumeration process is executed by the host, in a step 1312. During the enumeration process, the user host requests information such as a device type and its configuration characteristics. Next, pre-programmed values stored in the reserved area are returned to the user host, in a step 1314. If a flash memory chip is empty, default hard-coded values are provided. The user host assigns new addresses to the flash memory each time during the enumeration process. The firmware records new address values for on-going transactions.

Next, the firmware responds to mass storage class BOT requests, in a step 1316. For example, a request can be for the maximum LUN supported by the device. As such, the correct numbers stored in the reserved area are returned to the user host. If the flash memory is empty, a default value (e.g. 00h, or at least one LUN) is returned.

Next, CBW inquiry commands are responded to, in a step 1318. Since the number of partitions is known in advance, an LUN counter increments after each partition returns its characteristic value. The original CBW is replaced with a current LUN value for storing MBR/PBR system file structures to the flash memory. For various CBW commands, firmware provides subroutines to execute different commands including commands for recycling of old used blocks. Next, CBW commands are accepted, in a step 1320.

### Security Partition

In a specific embodiment, a secured partition and a public partition share the same logic unit number. In accordance with the present invention, a security utility program allows a secured partition and a public partition to share the same LUN number of the flash memory. Accordingly, the OS can process data from these areas without distinguishing between the partitions. In a specific embodiment, the capacity volume of each partition can be varied with a fixed total size. This can be done using a utility program. This is beneficial because it provides flexibility for data storage.

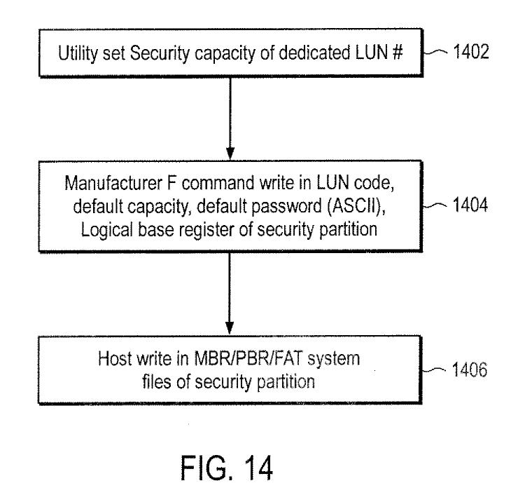

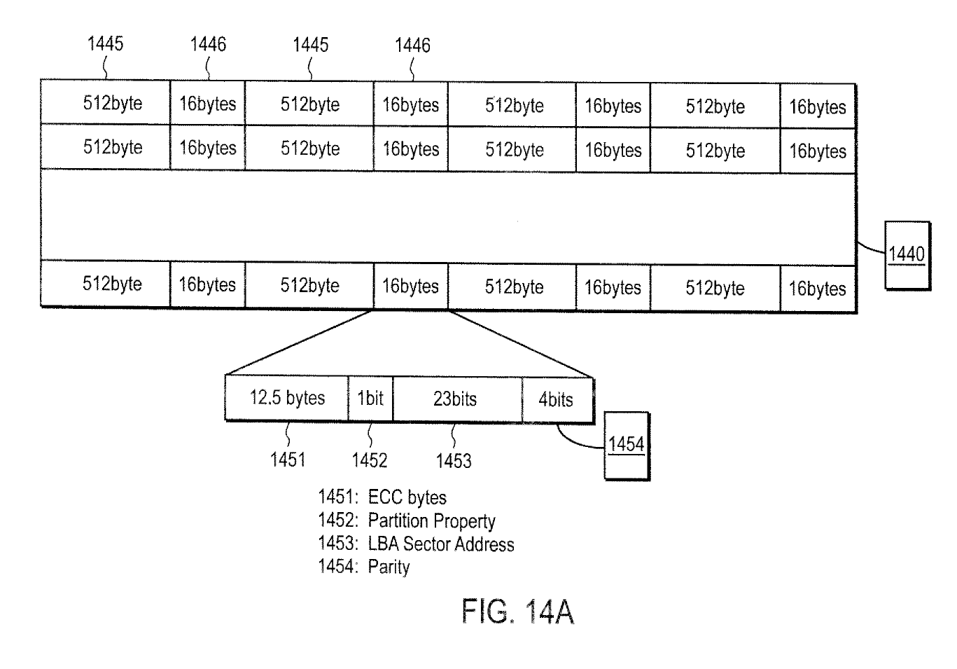

FIG. 14 is a flow chart showing a method for setting up a security partition of the manufacturing test in accordance with the present invention. First, an initial capacity is set for a dedicated secured partition, in a step 1402. Next, a LUN code, a default capacity, a default password, and logical base address registers are written, in a step 1404. Next, MBR/PBR/FAT system files of the security partition are written, in a step 1406.

FIG. 14A is a block diagram illustrating a physical block structure of a flash memory according to one embodiment of the invention. Referring to FIG. 14A, a physical block 1440 structure is used as an example to show how a secured partition and a public partition share the same logic unit number but distinguished by the controller to be allocated in different physical blocks. For a MLC (multi-level cell) flash memory, typically a block size has 128 pages, and each page includes a data area having 2048 bytes and a spare area having 64 bytes. In one embodiment, one page may be divided into 4 sectors each having a 512-byte data area 1445 and a 16-byte spare area 1446. Sixteen-byte spare area 1446 is mainly used for ECC protection 1451 and wear leveling. In FIG. 14A, 12.5 bytes in 16-byte spare area 1451 are defined for ECC usage, and 3 bytes are used for wear leveling. These 3 bytes are used to record the logic block information and error protection. However, in order to mark this block to be used as a secured partition or a public partition, at least one bit 1452 in these 3 bytes is specially defined as a flag of a partition property while the rest 23 bits are defined for LBA sector Address 1453. In the figure, four-bit parity 1454 is applied to protect 1452 and 1453. Therefore, the controller can access data in the corresponding physical block correctly even the two partitions share the same logic unit number.

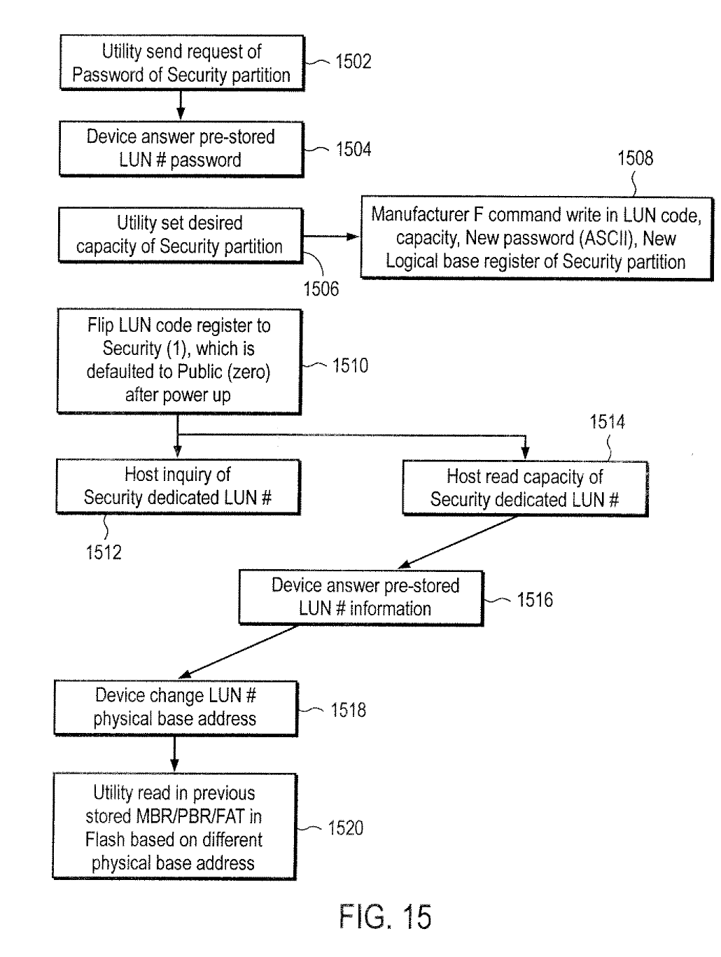

FIG. 15 is a flow chart showing a method for operating a secured partition in a user mode in accordance with one embodiment of the present invention. First, a password for the secured partition is requested, in a step 1502. Next, a pre-stored LUN password is provided for matching purposes, in a step 1504. Next, a capacity for the secured partition is set, in a step 1506. Next, a LUN code, a capacity, a new update password, and logical base registers are written, in a step 1508. Next, a LUN code register is set to a secured mode, in a step 1510. The default mode is a public mode after power up. Next, the LUN for the secured partition is requested by the user host in the case where the secured partition and the public partition are not sharing the same LUN, in a step 1512. Next, the capacity of the secured partition is read by the user host, in a step 1514. Next, pre-stored LUN information is provided, in a step 1516. Next, a physical base address for the secured partition is provided, in a step 1518. Next, previously stored MBR/PBR/FAT information in the flash is read, in a step 1520. Password protected secured partition can share with a public data partition with same LUN. After powering up the flash memory system, a default public area will appear. A security utility program is requested and the correct password is given to enable the security function.

A secured partition can exist in a storage area of the flash memory. A default capacity is loaded by a manufacturer utility, and a special driver is used by the manufacturing host for power-up formatting so that the user can perform his or her own initial formatting after receiving the flash memory device. If a correct password is provided upon a utility software inquiry request, an attribute register is set so that the user can choose a secured partition over a public partition.

New MBR, PBR, FAT values are stored in the flash memory by the user host. Then, the user can save and access secured data that is password protected. After a user logs off, the previous public partition will be displayed because the attribute register resets by default. As such, the public partition LUN code will restore the LBA base register, and pre-stored system files will be read in order to maintain data consistency. Whenever the capacity or file structure changes, formatting is typically performed. As such, old data is erased and new system files are loaded.

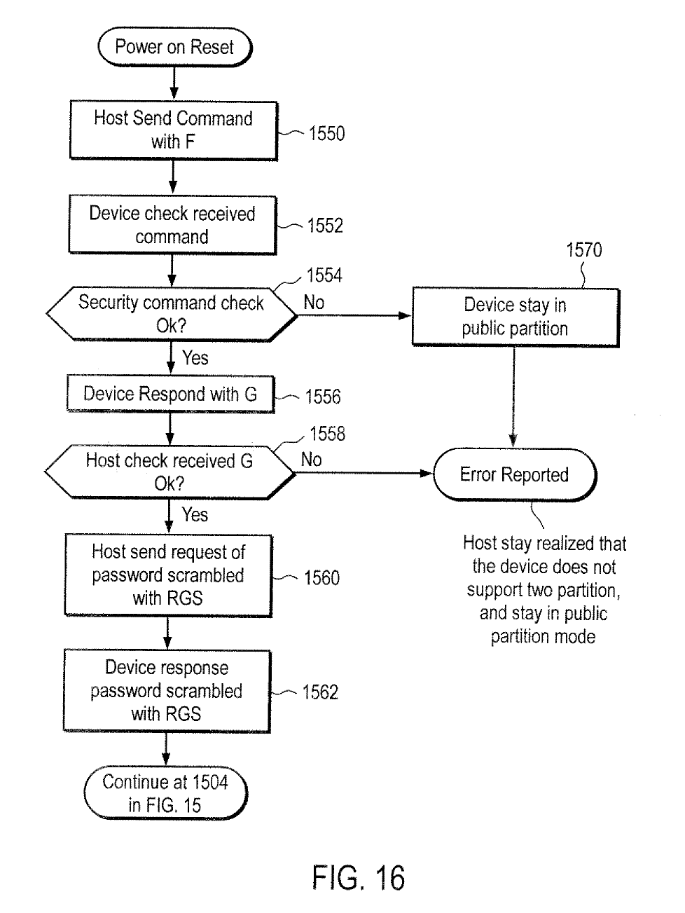

Further security protection may be required because the password is transferred between a host and device without any security mechanism in FIG. 15, and a hacker can “catch” the password by a logic analyzer or a bus analyzer. FIG. 16 is flow diagram illustrating a process for providing a secured communication link between a host and a flash memory device according to one embodiment of the invention. Referring to FIG. 16, after power up, the host and device both work in a public partition mode, and host will issue a security command with certain security bytes to the device (step 1550). The security bytes are generated by a predefined mathematic formula such as, for example, F=f (AUTH, RGS), where RGS is randomly generated seed. The security bytes are received by the device at step 1552 and verified at step 1554. Once the device successfully verifies the security bytes, the device responds with another certain security bytes (step 1556), which are generated by another predefined formula, such as, for example, G=G (AUTH, RGS). After G qualified by the host, the host and device are recognized by each other. This procedure is also referred to as an “Authorization”. After Authorization process finished, the host and the device can transfer the password, which is the decoding seed of the secured data. Since the authorization and password transferred between the host and device are physically transferred as certain security bytes generated from form a G and F under RGS, the bytes on bus between the host and device are in random pattern, which directly avoid any hacker's attempts. Step 1560 and 1662 can be used to replace step 1502 in FIG. 15 as an enhanced protection during acquiring password. After the Authorization is passed successfully and password is transferred with RGS scrambled, the controller can go ahead as FIG. 15 described.

According to the system and method disclosed herein, an embodiment of the present invention provides numerous benefits. For example, it provides a more flexible flash memory system by increasing its functionality. Also, the present invention can be applied to any controller-embedded Flash card including but not limited to MultiMediaCard (MMC), Secure Disk (SD), Memory Stick (MS), Compact Flash (CF), PCI Express, IDE, SATA, etc.

A system for implementing a flash memory system has been disclosed. The flash memory system includes flash memory having multiple partitions. The flash memory system can utilize the multiple partitions to provide multiple functions. The functions can include, for example, an AutoRun function, non-secured data storage, and secured data storage.

Although the present invention has been described with respect to certain specific embodiments, it will be clear to those skilled in the art that the inventive features of the present invention are applicable to other embodiments as well, all of which are intended to fall within the scope of the present invention. For example, while the systems and methods described herein are specifically directed to USB devices, the spirit and scope of the present invention is intended to cover different interface bus types, which may include one or more of PCI Express, Secure Digital (SD), Memory Stick (MS), Compact Flash (CF), IDE and SATA. Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), erasable programmable ROMs (EPROMs), electrically erasable programmable ROMs (EEPROMs), magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method operations. The required structure for a variety of these systems will appear from the description below. In addition, embodiments of the present invention are not described with reference to any particular programming language. It will be appreciated that a variety of programming languages may be used to implement the teachings of embodiments of the invention as described herein.

A machine-readable medium may include any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

1. An electronic data flash card adapted to communicate with a host computer through a communication link established by the host computer over an interface bus, said electronic data flash card comprising:
(A) a card body;
(B) a flash memory device mounted on the card body and including a plurality of flash memory cells, wherein the plurality of flash memory cells include at least one autorun partition having a first file system format, and at least one disk partition having a second file system format, wherein at least one disk partition includes a public data partition and a secured data partition sharing an identical logical unit number (LUN) and located at different physical blocks, and wherein each physical block includes at least one bit to be used to indicate whether a data partition associated with the respective physical block is a secured data partition or a public data partition;
(C) an input/output interface circuit mounted on card body and including means for establishing said communication link between the host computer and the electronic data flash card when the electronic data flash card is operably connected to the host computer; and
(D) a flash memory controller mounted on the card body and electrically connected to said flash memory device and said input/output interface circuit, wherein the flash memory controller comprises:
means for automatically executing a predetermined application stored in said at least one autorun partition when said communication link is established between the host computer and the electronic data flash card; and
means for operating, after initiating execution of said predetermined application, in one of:
a programming mode in which said flash memory controller activates said input/output interface circuit to receive a data file from the host computer, and stores the data file in said disk partition;
a data retrieving mode in which said flash memory controller reads said data file from said disk partition, and activates said input/output interface circuit to transmit the data file to the host computer; and
a data resetting mode in which the data file is erased from the disk partition.

2. The electronic data flash card of claim 1, wherein said autorun partition is formatted using one of CD-ROM file system (CDFS) and Universal file system (UFS), and wherein said disk partition is formatted using one of a file allocation table (FAT) file system and a New Technology file system (NTFS).

3. The electronic data flash card according to claim 1, wherein said predetermined application comprises causing a display of the host computer to display a predetermined advertisement before operating in said one of said programming mode said data retrieving mode and said data resetting mode.

4. The electronic data flash card according to claim 3, wherein said predetermined advertisement is stored in said at least one autorun partition such that erasure of said predetermined advertisement in said programming and data resetting mode is prevented.

5. The electronic data flash card according to claim 1, wherein said predetermined application comprises means for causing the host computer to execute a predetermined diagnostic routine.

6. The electronic data flash card according to claim 1, wherein said predetermined application comprises means for causing the host computer to facilitate access to restricted data stored on the host computer.

7. The electronic data flash card according to claim 1, wherein said predetermined application comprises means for causing the host computer to implement predetermined user-customized system settings.

8. The electronic data flash card according to claim 1, wherein said at least one disk partition comprises at least one public partition and at least one secured partition.

9. The electronic data flash card according to claim 1, wherein the plurality of flash memory cells further comprise a reserved space including dynamic boot code and control code.

10. The electronic data flash card according to claim 1, further comprising an index coupled to the flash memory controller, wherein the index comprises information regarding a configuration of the at least one flash memory device, wherein the index provides access to the at least one autorun partition and the at least one disk partition.

11. The electronic data flash card of claim 10 wherein the index associates logic unit numbers (LUNs) with each of the at least one autorun partition and the at least one disk partition.

12. The electronic data flash card of claim 11 wherein one LUN corresponds to one or more of said at least one autorun partition and said at least one disk partition.

13. The electronic data flash card of claim 11 wherein the index maps the LUNs to logical block addresses (LBAs) and physical address blocks (PBAs) associated with the plurality of flash memory cells.

14. The electronic data flash card of claim 1 wherein the electronic data flash card comprises a universal serial bus (USB) compatible device.

15. The electronic data flash card of claim 1 wherein the flash memory controller comprises one of a 8032 processor, a 80286 processor, a RISC processor, an ARM processor, a MIPS processor and a digital signal processor.

16. The electronic data flash card of claim 1 wherein the input/output interface circuit comprises one of a Universal Serial Bus (USB), Secure Digital (SD), Multi-Media Card (MMC), Compact Flash (CF), Memory Stick (MS), PCI-Express (PCIE), Integrated Drive Electronics (IDE), and a Serial Advanced Technology Attachment (SATA) interface circuit.

17. The electronic data flash card of claim 1, wherein each physical block includes a plurality of pages, each page having a plurality of sectors, wherein each sector includes a data area and a spare area, and wherein the spare area includes an attribute indicating whether a data partition associated with the respective physical block is a secured data partition.

18. The electronic data flash card of claim 17, wherein each page includes four sectors each including a data area having a size of 512 bytes and a spare area having a size of 16 bytes, wherein the spare area includes an ECC (error correction code) field, a partition property field indicating whether the associated data partition is a secured partition, an LBA sector address field, and a parity field used to protect data stored in the partition property field and the LBA sector address field.

19. The electronic data flash card of claim 18, wherein the ECC field includes 12.5 bytes, wherein the partition property field includes one bit, wherein the LBA sector address field includes 23 bits, and wherein the parity field includes 4 bits.

20. A system comprising:
a host computer including an interface bus; and
an electronic data flash card adapted to communicate with the host computer through a communication link established by the host computer over the interface bus, said electronic data flash card comprising:
(A) a card body;
(B) a flash memory device mounted on the card body and including a plurality of flash memory cells, wherein the plurality of flash memory cells include at least one autorun partition having a first file system format, and at least one disk partition having a second file system format;
(C) an input/output interface circuit mounted on card body and including means for establishing said communication link between the host computer and the electronic data flash card when the electronic data flash card is operably connected to the host computer; and
(D) a flash memory controller mounted on the card body and electrically connected to said flash memory device and said input/output interface circuit,
wherein the host computer sends a first command to the electronic data flash card, the first command having one or more secured bytes generated using a first predetermined function based on a randomly generated seed (RGS) value,
wherein in response to and upon successfully verifying the first command, the flash memory controller sends a second command to the host computer, the second command having one or more secured bytes generated using a second predetermined function based on the RGS value,
wherein in response to and upon successfully verifying the second command, the host computer sends a third command to the electronic data flash card requesting for a password, the third command being scrambled with the RGS value, and
wherein in response to the third command, the electronic data flash card sends the requested password scrambled with the RGS value to the host computer, and thereafter, the host computer and the electronic data flash card exchange data protected by the password.
